(19) United States
(12) Patent Application Publication
(10) Pub. No.: US 2026/0082342 A1
(43) Pub. Date: Mar. 19, 2026

(54) SYNCHRONIZATION SIGNAL BLOCK BURSTS FOR A NEAR-FIELD REGION AND A FAR-FIELD REGION OF AN ANTENNA ARRAY

(71) Applicant: Lenovo (United States) Inc., Morrisville, NC (US)

(72) Inventors: Karthikeyan Ganesan, Kronberg im Taunus (DE); Ali Ramadan Ali, Kraiburg am Inn (DE)

(21) Appl. No.: 18/885,509

(22) Filed: Sep. 13, 2024

(51) Int. Cl. H04W 56/00; H04B 7/06; H04W 74/0833

(52) U.S. Cl. CPC H04W 56/0015; H04B 7/0626; H04B 7/06968; H04W 74/0833

(57) ABSTRACT

Various aspects of the present disclosure relate to transmitting a configuration that indicates a mapping between a synchronization signal block (SSB) transmission to a random-access channel occasion (RO), where the mapping is according to whether the SSB transmission is for a near-field region associated with an antenna array or for a far-field region associated with the antenna array. Aspects of the present disclosure relate to transmitting a plurality of SSB bursts based at least in part on the configuration, where the plurality of SSB bursts comprises a first SSB burst and a second SSB burst, the first SSB burst comprising a first set of SSBs associated with a first set of beams for the near-field region, and the second SSB burst comprising a second set of SSBs associated with a second set of beams for the far-field region.

### TECHNICAL FIELD

The present disclosure relates to wireless communications, and more specifically to techniques for configuring a set of synchronization signal block (SSB) bursts for a near-field region and a far-field region.

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

Some implementations of the method and apparatuses described herein may transmit a configuration that indicates a mapping between a synchronization signal block (SSB) transmission to a random-access channel occasion (RO), wherein the mapping is according to whether the SSB transmission is for a near-field region associated with an antenna array or for a far-field region associated with the antenna array. In certain implementations, the method and apparatuses described herein may transmit a plurality of SSB bursts based at least in part on the configuration, wherein the plurality of SSB bursts comprises a first SSB burst over a first set of beams for the near-field region associated with the antenna array, and a second SSB burst over a second set of beams for the far-field region associated with the antenna array, wherein the first SSB burst comprises a first set of SSBs, and wherein the second SSB burst comprises a second set of SSBs.

### BRIEF DESCRIPTION OF THE DRAWINGS

FIG. 1 illustrates an example of a wireless communications system in accordance with aspects of the present disclosure.

FIG. 2 illustrates an example of a protocol stack in accordance with aspects of the present disclosure.

FIG. 3 illustrates an example of regions associated with an antenna array in accordance with aspects of the present disclosure.

FIG. 4 illustrates an example of a planar wavefront during far-field communication in accordance with aspects of the present disclosure.

FIG. 5 illustrates an example of a spherical wavefront during near-field communication in accordance with aspects of the present disclosure.

FIG. 6 illustrates an example of a first stage of far-field beam training in accordance with aspects of the present disclosure.

FIG. 7 illustrates an example of a second stage of far-field beam training in accordance with aspects of the present disclosure.

FIG. 8 illustrates an example of a first stage of near-field beam training in accordance with aspects of the present disclosure.

FIG. 9 illustrates an example of a second stage of near-field beam training in accordance with aspects of the present disclosure.

FIG. 10 illustrates an example of a comparison between convergence rates in accordance with aspects of the present disclosure.

FIG. 11 illustrates an example of a comparison between near-field regions for different frequency bands in accordance with aspects of the present disclosure.

FIG. 12 illustrates an example of a communication scenario, involving both near-field and far-field communications, in accordance with aspects of the present disclosure.

FIG. 13 illustrates an example of a random access channel (RACH) configuration information element (IE) in accordance with aspects of the present disclosure.

FIG. 14 illustrates another example of a RACH configuration IE in accordance with aspects of the present disclosure.

FIG. 15 illustrates an example of a fully connected precoding architecture in accordance with aspects of the present disclosure.

FIG. 16 illustrates an example of a sub-connected precoding architecture in accordance with aspects of the present disclosure.

FIG. 17 illustrates an example of a hybrid precoding architecture in accordance with aspects of the present disclosure.

FIG. 18 illustrates an example of an SSB burst comprising multiple SSB transmissions, in accordance with aspects of the present disclosure.

FIG. 19 illustrates an example of a polar domain mapping of near-field and far-field beams, in accordance with aspects of the present disclosure.

FIG. 20 illustrates an example of a UE in accordance with aspects of the present disclosure.

FIG. 21 illustrates an example of a processor in accordance with aspects of the present disclosure.

FIG. 22 illustrates an example of a network equipment (NE) in accordance with aspects of the present disclosure.

FIG. 23 illustrates a flowchart of a method performed by a NE in accordance with aspects of the present disclosure.

### DETAILED DESCRIPTION

In a wireless communications system, one or more of NE and UE may perform wireless communication (e.g., downlink (DL) communication, uplink (UL) communication, sidelink (SL) communication, etc.) over various frequency ranges. Wireless communications at high frequencies (e.g., 6 GHz and beyond) may support wider carrier bandwidths (e.g., a range of frequencies for wireless communication). Additionally, wireless communications at high frequencies may facilitate more complex modulation and coding scheme (MCS), thereby increasing the data rate. Accordingly, it is desirable for future wireless communication systems to support wireless communications at the high frequencies.

In some wireless communication systems, such as 5G systems, a base station (e.g., a gNB) may support multiple-input, multiple-output (MIMO) technology to improve capacity, coverage, and spectral efficiency. In some implementations, the base station may be configured with a large number of antenna array elements to perform MIMO communications (also, referred to as “massive MIMO”). For example, for a base station operating in the sub-6 GHz spectrum (i.e., frequencies below 6 GHZ), the number of antenna array elements might range from 8 to 64 elements, where antenna configurations such as 8×8 (i.e., 8 transmit (Tx) antennas-by-8 receive (Rx) antennas), 16×16, and 32×32 may be deployed. As another example, for a base station operating in the mmWave spectrum (e.g., frequency of 24 GHz and above), the number of elements in the antenna array may be larger, such as antenna configurations from 64 to 256 elements. Because the physical dimension of an antenna element is proportional to the operating wavelength, the shorter wavelengths of mmWave deployments allow for more antenna array elements (e.g., of an antenna array) to be arranged into the same (or smaller) physical space (e.g., footprint).

Employing a large number of antenna array elements allows for advanced beamforming techniques, where the base station can focus a signal towards specific UEs, improving signal strength and reducing interference. This in turn allows the base station to utilize spatial multiplexing (SM) techniques, wherein the base station is able to serve multiple UEs simultaneously, each with their own beam, thereby increasing the overall capacity of the base station.

Moreover, future deployments (e.g., 6G and beyond) of wireless communication systems for frequency bands in the 7 GHz to 24 GHz range are expected to support antenna arrays composed of thousands of antenna array elements, referred to as “XL-MIMO”. For example, an XL-MIMO deployment in 6G may comprise around 5000 antenna array elements.

However, as system bandwidth and number of antenna array elements of an antenna array increases, mutual coupling between the antenna array elements (e.g., in XL-MIMO systems) increases a size of a near-field region of the antenna array (e.g., a region where generated electromagnetic (EM) waves exhibit a spherical wavefront rather than a planar wavefront).

There are two aspects of the near-field region associated with the antenna array. First, the reactive near-field region refers to a region closest (e.g., distance) to the antenna array element where the EM wave is influenced (e.g. affected, impacted) by the magnetic and induction coupling from the antenna array element and exhibits evanescent waves whose energy decays very rapidly with distance. Secondly, the radiating near-field, also known as Fresnel region, refers to the region located between the reactive near-field region and the far-field region. The radiating near-field is the region where the EM waves are in a transitioning phase but exhibit a radiating pattern typical of the near-field since the radiating patten is not fully transformed, the radiating pattern varies with distance. The Fraunhofer distance is a theoretical limit where the EM waves exhibit planar radiating pattern.

Due to different radiating patterns in the near-field and far-field regions, transmission beams also have different behaviors and characteristics between the near-field and far-field regions. Because legacy SSB-RACH beam association (e.g., according to the 3GPP-defined parameter ssb-perRACH-OccasionAndCB-PreamblesPerSSB) overlooks the type of radiating pattern (e.g., near-field or far-field) of a transmission beam, the legacy SSB-RACH beam association is insufficient for XL-MIMO.

In certain embodiments, a base station may communicate additional information, such as an indication of a type of beam for a UE. The type of beam may be a near-field beam (i.e., exhibiting a spherical wavefront, thus having a focusing area within the near-field region and defined by both distance and direction) or a far-field beam (i.e., exhibiting a planar wavefront, thus defined by a direction (e.g., angular domain) in the far-field region), the particular beam aligned in the UE's direction and providing best possible (i.e., highest) signal strength and/or signal quality) and that may support reliable wireless communication between the base station and the UE. The additional information may be of assistance when performing beam scheduling, beam switching, beam refinement, beam measurement, etc. For example, an SSB-RACH association for near-field beams may be separately indicated from the SSB-RACH association for far-field beams, such that each SSB-RACH association indicates the type of beam served to the UE. Accordingly, the UE may consider any quasi-co-location (QCL) among those SSB beams, e.g., during initial access.

Accordingly, aspects of the present disclosure include techniques at a base station for SSB-RACH association to indicate, to a UE, a near-field beam or a far-field beam relationship of a SSB beam. Determining additional information about the type of beam served to the UE may assist the base station when scheduling different beams. Aspects of the present disclosure further consider a relationship (e.g., QCL relationship) between the near-field and far-field beams to enable beam switching, at a UE, between near-field and far-field beams. Consequently, aspects of the present disclosure provide separate SSB burst for near-field and far-field and a separate SSB-RACH resource mapping for near-field and far-field SSBs for near-field and far-field UE beam determination at the base station during an initial access procedure, as described in more detail below.

Aspects of the present disclosure describe how near-field and far-field SSB beams of SSB bursts can be quasi-co-located (QCL′ed) to enable UE to refine the near-field beam according to the far-field beam. Aspects of the present disclosure describe how a near-field SSB beam can be a sub-index of a far-field SSB beam. Aspects of the present disclosure describe a new channel state information reference signal (CSI-RS) configuration for the near-field and far-field, beam failure detection. Aspects of the present disclosure are described in the context of a wireless communications system.

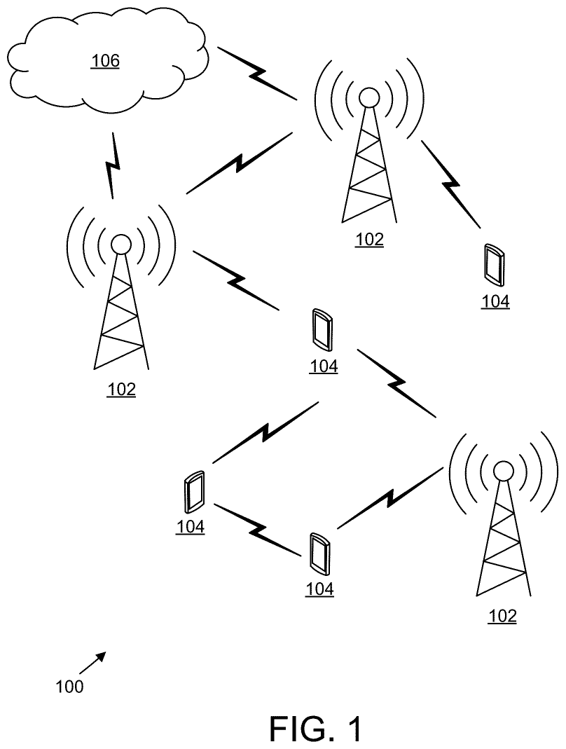

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as a Long-Term Evolution (LTE) network or an LTE-Advanced (LTE-A) network. In some other implementations, the wireless communications system 100 may be a New Radio (NR) network, such as a 5G network, a 5G-Advanced (5G-A) network, or a 5G ultrawideband (5G-UWB) network.

In other implementations, the wireless communications system 100 may be a combination of a 4G network and a 5G network, or other suitable radio access technology (RAT) including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an internet-of-things (IoT) device, an internet-of-everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N3, or network interface). In some implementations, the NE 102 may communicate with each other directly. In some other implementations, the NE 102 may communicate with each other indirectly (e.g., via the CN 106). In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management function (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signaling bearers, etc.) for the one or more UEs 104 served by the one or more NE 102 associated with the CN 106.

The CN 106 may communicate with a packet data network over one or more backhaul links (e.g., via an S1, N2, N3, or another network interface). The packet data network may include an application server. In some implementations, one or more UEs 104 may communicate with the application server. A UE 104 may establish a session (e.g., a protocol data unit (PDU) session, or a PDN connection, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively.

Each slot may include a number (e.g., quantity) of symbols (e.g., orthogonal frequency domain multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHZ-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations, one or more of the NEs 102 and the UEs 104 are operable to implement various aspects of the techniques described with reference to the present disclosure.

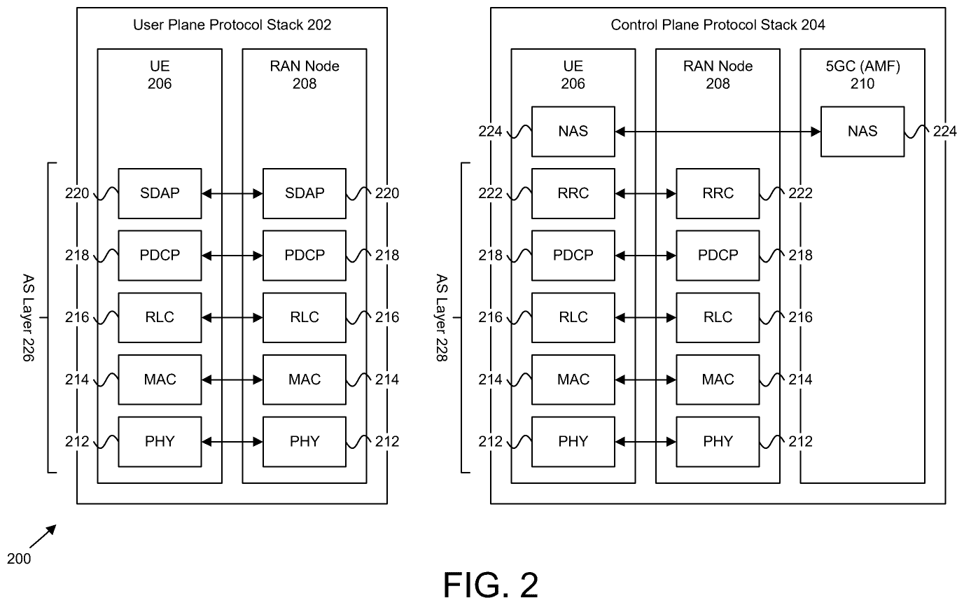

FIG. 2 illustrates an example of a protocol stack 200, in accordance with aspects of the present disclosure. While FIG. 2 shows a UE 206, a RAN node 208, and a 5G core network (5GC) 210 (e.g., comprising at least an AMF), these are representative of a set of UEs 104 interacting with an NE 102 (e.g., base station) and a CN 106. As depicted, the protocol stack 200 comprises a user plane protocol stack 202 and a control plane protocol stack 204. The user plane protocol stack 202 includes a physical (PHY) layer 212, a medium access control (MAC) sublayer 214, a radio link control (RLC) sublayer 216, a packet data convergence protocol (PDCP) sublayer 218, and a service data adaptation protocol (SDAP) sublayer 220. The control plane protocol stack 204 includes a PHY layer 212, a MAC sublayer 214, a RLC sublayer 216, and a PDCP sublayer 218. The control plane protocol stack 204 also includes a radio resource control (RRC) layer 222 and a NAS layer 224.

The AS layer 226 (also referred to as “AS protocol stack”) for the user plane protocol stack 202 consists of at least SDAP, PDCP, RLC and MAC sublayers, and the physical layer. The AS layer 228 for the control plane protocol stack 204 consists of at least RRC, PDCP, RLC and MAC sublayers, and the physical layer. The layer-1 (L1) includes the PHY layer 212. The layer-2 (L2) is split into the SDAP sublayer 220, PDCP sublayer 218, RLC sublayer 216, and MAC sublayer 214. The layer-3 (L3) includes the RRC layer 222 and the NAS layer 224 for the control plane and includes, e.g., an internet protocol (IP) layer and/or PDU Layer (not depicted) for the user plane. L1 and L2 are referred to as “lower layers,” while L3 and above (e.g., transport layer, application layer) are referred to as “higher layers” or “upper layers.”

The PHY layer 212 offers transport channels to the MAC sublayer 214. The PHY layer 212 may perform a beam failure detection procedure using energy detection thresholds, as described herein. In certain embodiments, the PHY layer 212 may send an indication of beam failure to a MAC entity at the MAC sublayer 214. The MAC sublayer 214 offers logical channels to the RLC sublayer 216. The RLC sublayer 216 offers RLC channels to the PDCP sublayer 218. The PDCP sublayer 218 offers radio bearers to the SDAP sublayer 220 and/or RRC layer 222. The SDAP sublayer 220 offers QoS flows to the core network (e.g., 5GC). The RRC layer 222 manages the addition, modification, and release of carrier aggregation and/or dual connectivity. The RRC layer 222 also manages the establishment, configuration, maintenance, and release of signaling radio bearers (SRBs) and data radio bearers (DRBs).

The NAS layer 224 is between the UE 206 and an AMF in the 5GC 210. NAS messages are passed transparently through the RAN. The NAS layer 224 is used to manage the establishment of communication sessions and for maintaining continuous communications with the UE 206 as it moves between different cells of the RAN. In contrast, the AS layers 226 and 228 are between the UE 206 and the RAN (i.e., RAN node 208) and carry information over the wireless portion of the network. While not depicted in FIG. 2, the IP layer exists above the NAS layer 224, a transport layer exists above the IP layer, and an application layer exists above the transport layer.

The MAC sublayer 214 is the lowest sublayer in the L2 architecture of the NR protocol stack. Its connection to the PHY layer 212 below is through transport channels, and the connection to the RLC sublayer 216 above is through logical channels. The MAC sublayer 214 therefore performs multiplexing and demultiplexing between logical channels and transport channels: the MAC sublayer 214 in the transmitting side constructs MAC PDUs (also known as transport blocks (TBs)) from MAC service data units (SDUs) received through logical channels, and the MAC sublayer 214 in the receiving side recovers MAC SDUs from MAC PDUs received through transport channels.

In the radio protocol architectures described herein, the term “SDU” refers to a data unit that is received by a sublayer from a higher sublayer, or that is sent by a sublayer to a higher sublayer. Likewise, the term “PDU” refers to a data unit that is sent by a sublayer to a lower sublayer, or that is received by a sublayer from a lower sublayer.

The MAC sublayer 214 provides a data transfer service for the RLC sublayer 216 through logical channels, which are either control logical channels which carry control data (e.g., RRC signaling) or traffic logical channels which carry user plane data. On the other hand, the data from the MAC sublayer 214 is exchanged with the PHY layer 212 through transport channels, which are classified as uplink (UL) or downlink (DL). Data is multiplexed into transport channels depending on how it is transmitted over the air.

The PHY layer 212 is responsible for the actual transmission of data and control information via the air interface, i.e., the PHY layer 212 carries all information from the MAC transport channels over the air interface on the transmission side. Some of the important functions performed by the PHY layer 212 include coding and modulation, link adaptation (e.g., adaptive modulation and coding (AMC)), power control, cell search and random access (for initial access synchronization and handover purposes) and other measurements (inside the Third Generation Partnership Project (3GPP) system (i.e., NR and/or LTE system) and between systems) for the RRC layer 222. The PHY layer 212 performs transmissions based on transmission parameters, such as the modulation scheme, the coding rate (i.e., the modulation and coding scheme (MCS)), the number of physical resource blocks (PRBs), etc.

In some embodiments, the protocol stack 200 may be an NR protocol stack used in a 5G NR system. Note that an LTE protocol stack comprises similar structure to the protocol stack 200, with the differences that the LTE protocol stack lacks the SDAP sublayer 220 in the AS layer 226, that an EPC replaces the 5GC 210, and that the NAS layer 224 is between the UE 206 and an MME in the EPC. Also note that the present disclosure distinguishes between a protocol layer (such as the aforementioned PHY layer 212, MAC sublayer 214, RLC sublayer 216, PDCP sublayer 218, SDAP sublayer 220, RRC layer 222 and NAS layer 224) and a transmission layer in multiple-input multiple-output (MIMO) communication (also referred to as a “MIMO layer” or a “data stream”).

As noted above, as the system bandwidth and the number of antenna array elements of an antenna array of a base station increases, the size of the near-field region also increases. Hence, for radio access technologies beyond 5G (e.g., 6G), beam management in the near-field region of the antenna array should be handled separate from the far-field region. Consequently, it is beneficial for the base station to be aware whether a UE is located within the near-field region or the far-field region associated with the antenna array of the base station.

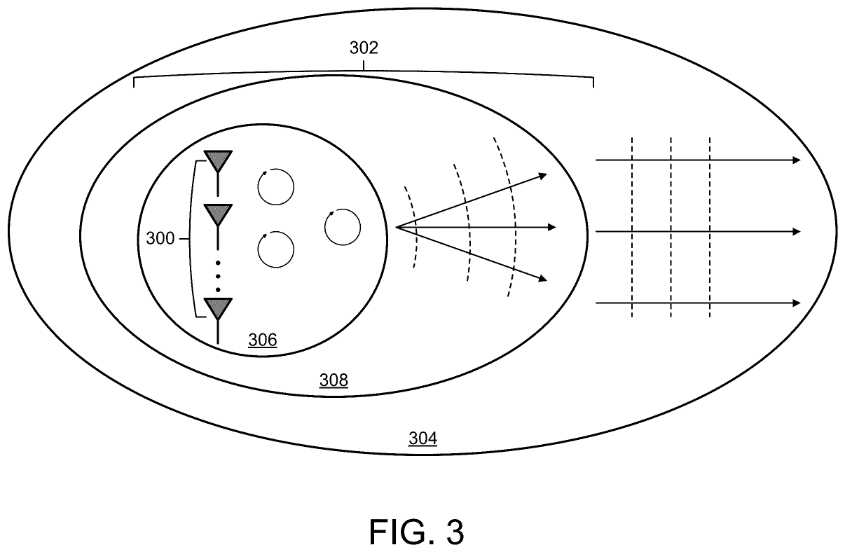

FIG. 3 depicts an example of regions associated with an antenna array in accordance with aspects of the present disclosure. In the example of FIG. 3, an antenna array 300 may be configured with a set of antenna array elements, and capable of transmitting a radio frequency (RF) signal (e.g., EM wave). The antenna array 300 may be associated with a near-field region 302 and a far-field region 304. A boundary between the near-field region 302 and the far-field region 304 might not be constant across all antenna arrays, as it depends on the dominant wavelength emitted by the source and the size (e.g., aperture) of the radiating element. The boundary between the reactive near-field region 306 and the radiative near-field region 308 is referred to as the “Rayleigh distance” or the “Fraunhofer distance” and may be defined as follows:

$$\frac{2 {D}^{2}}{λ}$$

where D is the maximum linear dimension of the antenna array (i.e., aperture of radiation), and λ is the wavelength of the EM wave.

The near-field region 302 refers to locations nearby the antenna conductors, or inside any polarizable media surrounding it, where the generation and emission of EM waves can be interfered with while the field lines remain electrically attached to the antenna array 300. The electric and magnetic fields can exist independently of each other in the near-field region 302, and one type of field can be disproportionately larger than the other, in different subregions.

The near-field region 302 may be further defined into a reactive near-field region 306 and a radiative near-field region 308. In the reactive near-field region 306 (nearest to the antenna array 300), an interaction with the medium (e.g., body capacitance) can cause energy to deflect back to the source feeding the antenna array 300. In the radiative near-field region 308 (i.e., further away from the antenna array 300), an interaction with the medium can fail to return energy back to the source but cause a distortion in the EM wave that deviates significantly from that found in free space. The boundary between the reactive near-field region 306 and the radiative near-field region 308 is referred to as the “Fresnel distance” and may be defined as follows:

$$0.62 \sqrt{\frac{{D}^{2}}{λ}}$$

where D is the maximum linear dimension of the antenna array (i.e., aperture of radiation), and λ is the wavelength of the EM wave. Accordingly, the boundaries of the radiative near-field region 308 may be defined as follows:

$$0.62 \sqrt{\frac{{D}^{2}}{λ}} < Radiative Near - Field < \frac{2 {D}^{2}}{λ} .$$

In contrast, the far-field region 304 (also referred to as the “Fraunhofer region”) is the region in which the field has settled into “normal” electromagnetic radiation. The far-field region 304 is dominated by transverse electric or magnetic fields with electric dipole characteristics. In the far-field region 304 of the antenna array 300, the radiated power decreases as the square of distance, and absorption of the radiation does not feed back to the transmitter. In some embodiments, the far-field region 304 begins approximately at the Rayleigh distance and extends to infinity.

Returning to FIG. 1, some beam-based access operations consider initial beam training, wherein a UE 104 measures different SSB beams and selects a best received SSB beam (e.g., according to a highest reference signal received power (RSRP). A NE 102 (e.g., a base station) may indicate one or more RACH resources by transmitting a system information block #1 (SIB1), wherein the SIB1 contains an SSB-RACH resource mapping relationship between an SSB transmission and an UL beam and RACH resource for a physical random access channel (PRACH) transmission. Thus, the initial beam training step (which is known as step “P1”) can be accomplished using the SSB-RACH resource mapping and beam association. The subsequent beam training step, referred to as beam refinement, may be performed during a connected mode procedure by the base station by transmitting CSI-RS using a narrower beam width QCL'ed with an SSB beam.

In far-field communication, beamforming can be used to steer a transmitted signal in a specific direction in the angular domain, similar to a flashlight, which is known as beam-steering. However, the near-field array response vector under the spherical wave assumption depends on both the angle and distance between transmitter and receiver. By taking advantage of this property, near-field channel beamforming can be designed to act like a spotlight, allowing focusing on a specific location in the polar domain defined by angle/direction and distance. This is known as beam-focusing and is different from far-field channel beamforming.

But, beam-focusing is not universally achievable in the near-field region. Instead, beam-focusing can only be achieved within a limited fraction, specifically within one-tenth, of the near-field region. For example, consider a base station with a Rayleigh distance of 350 m and a focusing region confined to just 35m according to the 3 dB depth of focus. Therefore, extremely large-scale antenna arrays (ELAAs) are crucial for near-field beam-focusing as they can realize both a large focusing region and a small depth of focus.

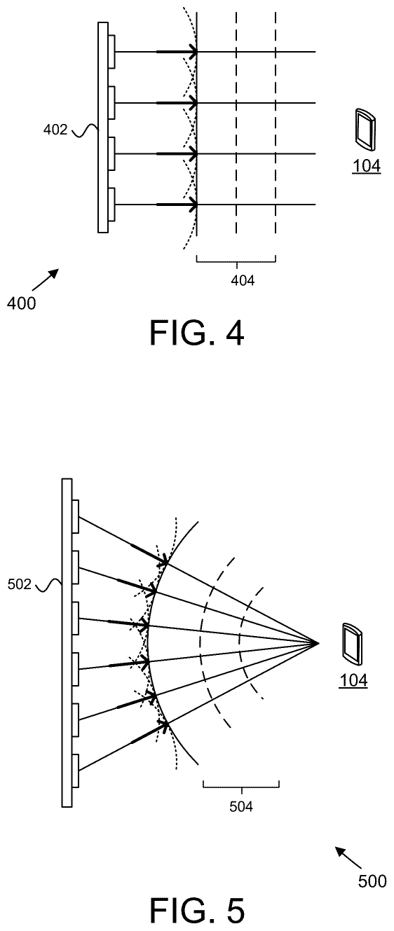

FIG. 4 illustrates an example 400 of a planar wavefront during far-field communication in accordance with aspects of the present disclosure. In the example of FIG. 4, a UE 104 is located in a far-field region of an antenna array 402 of a NE 102. The NE 102 and the UE 104 may be examples of NE and UE as described with reference to FIG. 1. As shown in FIG. 4, one or more radiative components associated with elements of the antenna array 402 coalesce into planar waves 404 in the far-field region.

FIG. 5 illustrates an example 500 of a spherical wavefront during near-field communication in accordance with aspects of the present disclosure. In the example of FIG. 5, a UE 104 is located in a near-field region of an antenna array 502 of a NE 102. The NE 102 and the UE 104 may be examples of NE and UE as described with reference to FIG. 1. The radiative components associated with the elements of the antenna array 502 create a spherical wavefront 504 in the near-field region.

Depth of focus is an important metric for evaluating the attainability of the orthogonality of near-field array response vectors in the distance domain. From the signal-to-interference-plus-noise ratio (SINR) perspective, when a user is located in the same direction but out of the depth of focus, the interference generated by beamformer f is relatively small. Consequently, a smaller depth of focus indicates better beam-focusing performance. Typically, the depth of focus is calculated based on a 3 dB criterion. It can be observed that the depth of focus tends to infinity if the focus distance r is larger than the threshold for the depth of focus. This implies that beam-focusing degenerates to beam-steering, since the orthogonality in the distance domain is almost lost. Therefore, the region within distance defined as depth of focus is referred to as the focusing region, where beam-focusing is achievable.

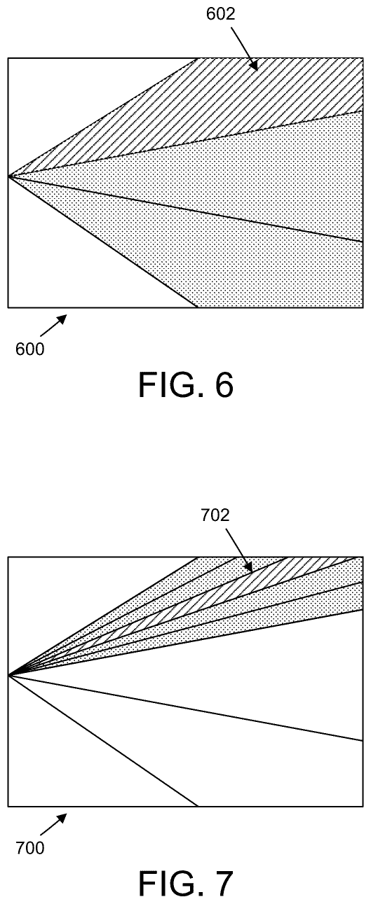

FIG. 6 illustrates an example of a first stage of far-field beam training in accordance with aspects of the present disclosure. In the example of FIG. 6, a first stage 600 of far-field beam training is depicted, where a UE measures at least three SSB beam. The first stage 600 involves the initial selection of a best SSB beam 602, e.g., based on the measurements. In certain embodiments, using an SSB-RACH resource mapping, the UE indicates the best SSB beam to the gNB.

FIG. 7 illustrates an example of a second stage of far-field beam training in accordance with aspects of the present disclosure. In the example of FIG. 7 a second stage 700 of the far-field beam training is depicted, where the UE measures at least three CSI-RS beams and selects the best CSI-RS beam 702. Here, the at least three CSI-RS beams are co-located with the best SSB beam 602 selected during the initial beam training step. The beam refinement procedure is the second stage of beam training and involves the subsequent selection of the narrower CSI-RS beam 702 transmitted within the wider SSB transmission beam 602 selected in the first stage.

In the near-field training process, the beams vary in distance as an additional dimension even for the same angular directions and thus it is easier to create orthogonal (i.e., non-interfering) links for users at different distances from the antenna array via near-field beam-focusing than it is for far-field beamforming.

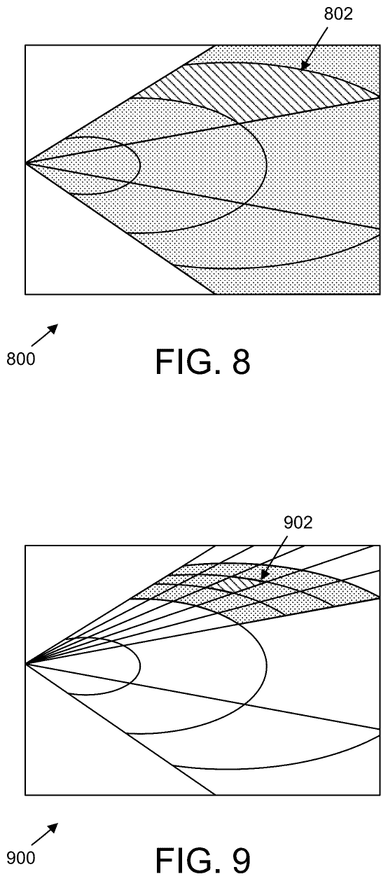

FIG. 8 illustrates an example of a first stage of near-field beam training in accordance with aspects of the present disclosure. In the example of FIG. 8 a first stage 800 of near-field beam training is depicted, where the UE performs initial selection of an optimal SSB “spotlight” beam 802 from among multiple candidate SSB “spotlight” beams. In certain embodiments, using an SSB-RACH resource mapping, the UE indicates the best SSB beam to the gNB.

FIG. 7 illustrates an example of a second stage of far-field beam training in accordance with aspects of the present disclosure. In the example of FIG. 9 second stage 900 of near-field beam training is depicted, where the UE measures multiple candidate CSI-RS beams that are co-located with the best SSB beam 802 selected during the initial beam training step. Here, UE selects the best CSI-RS beam 902, e.g., based on the CSI-RS measurements. The second stage 900 is the beam refinement procedure and involves the subsequent selection of the narrower CSI-RS beam 902 transmitted within the wider SSB transmission beam 802 selected in the first stage, where the narrower beam is a “spotlight” beam defined by both direction and distance from the antenna array.

In the near-field beam-focusing, the rank of the MIMO near-field channel varies according to the distance from the base station due to spherical wavefront enhancing spectral efficiency within the near-field region. The phases vary non-linearly across antenna array elements (e.g., of an antenna array) and the assumption of equal angle-of-arrival and/or angle-of-departure (AoA/AoD) becomes invalid. Thus, for the same signal path, the amplitudes of different array elements may no longer be equal due to the non-uniform spherical wavefront, as depicted in FIG. 4. However, the MIMO channel rank converges to that of far-field MIMO as the distance increases and wavefront changes to planar, as depicted in FIG. 5. Accordingly, a gNB having an XL-MIMO array can first generate polar-domain wide beams to find the coarse user angle and distance, and then gradually refine it using narrower beams.

Regarding the rate of channel matrix convergence for a spherical wavefront, in a pure line-of-sight (LOS) scenario, as a UE moves away from a gNB panel, the channel matrices obtained via spherical wavefront modelling (SWM) converge to that obtained via planar wavefront modelling (PWM).

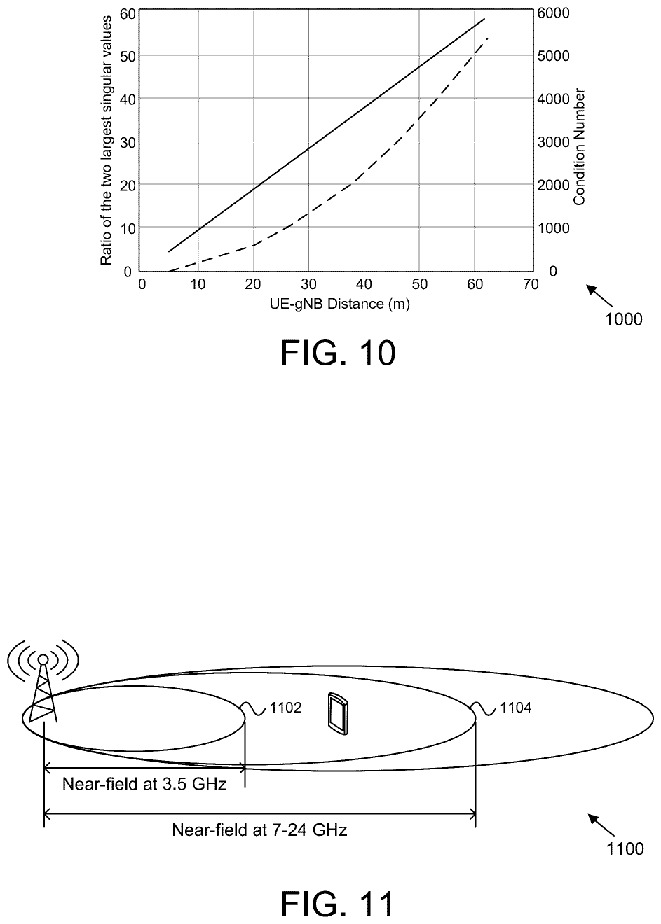

FIG. 10 illustrates an example of a comparison between convergence rates in accordance with aspects of the present disclosure. In the example of FIG. 10, a chart 1000 compares the rate of convergence via condition number of the channel matrix and via the ratio of the two largest singular values, in accordance with aspects of the present disclosure. It can be seen that the channel converges rather quickly to a rank-1 matrix as the UE-gNB distance grows.

FIG. 11 illustrates an example of a comparison between near-field regions for different frequency bands in accordance with aspects of the present disclosure. In the example of FIG. 11, a comparison 1100 of the relative sizes of near-field regions for different frequency bands is depicted. For a carrier frequency of 3.5 GHZ, the near-field region 1102 extends approximately half the distance from the antenna array as compared to the near-field region 1104 for a carrier frequency of 7 GHZ, assuming the same aperture of radiation.

Table 1 provides different examples of the boundary between the near-field and the far-field for ELAAs.

TABLE 1

| | | D | λ | 2D²/λ |
|---|---|---|---|---|
| Frequency | | (Antenna dimension) | (wavelength) | (near-field boundary) |
| 3.5 | GHz | 25 cm/50 cm/80 cm | 8.6 cm | 1.5 m/5.8 m/15 m |
| 7 | GHz | 25 cm/50 cm/80 cm | 4.3 cm | 2.9 m/11.6 m/30 m |
| 15 | GHz | 25 cm/50 cm/80 cm | 2.0 cm | 6.2 m/25 m/64 m |
| 24 | GHz | 10 cm/20 cm | 1.2 cm | 1.6 m/6.6 m |

Accordingly, while the distance of the near-field region is inversely proportional to the carrier frequency for the same antenna dimension (i.e., aperture of radiation), the distance of the near-field region increases exponentially as the antenna dimension increases, assuming the same carrier frequency.

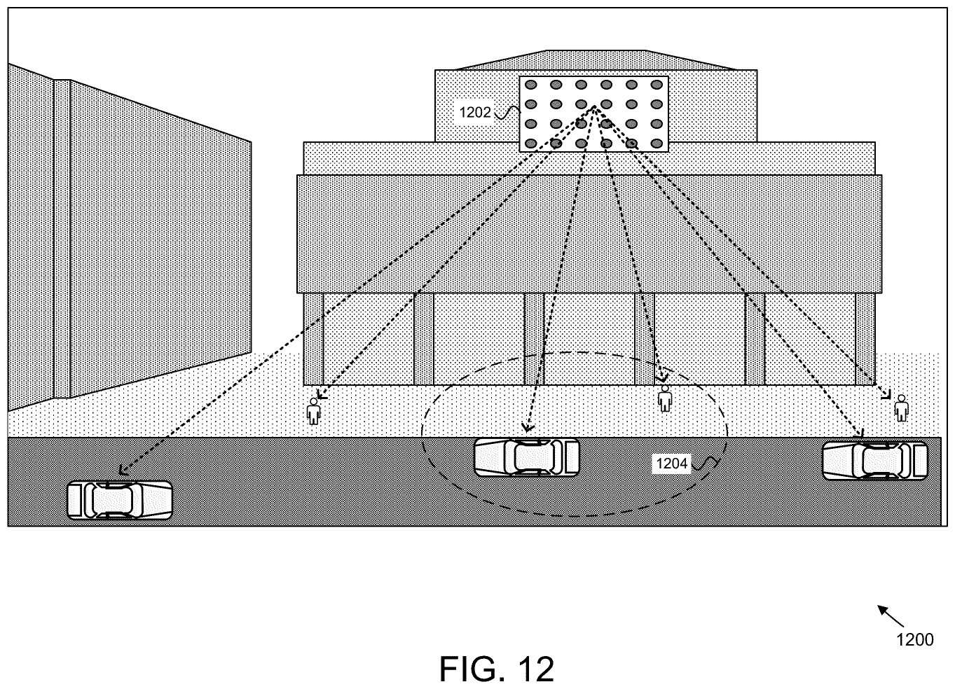

FIG. 12 illustrates an example of a communication scenario, involving both near-field and far-field communications, in accordance with aspects of the present disclosure. In the example of FIG. 12, the communication scenario 1200 may be performed by an antenna array 1202 of a base station (e.g., gNB). The base station may be one example of the NE 102 as described with reference to FIG. 1. Within a near-field region 1204, near-field communication is achieved using near-field beams, i.e., “spotlight” beams exhibiting a spherical wavefront and characterized by both distance and angular direction due to the spherical wavefront. However, outside the near-field region 1204 (i.e., in the far-field region of the antenna array 1202), communication is achieved using far-field beams exhibiting a planar wavefront and characterized by angular direction due to the planar wavefront. Accordingly, the base station may transmit one set of SSB for the near-field region 1204 and another set of SSB for the far-field region, in accordance with aspects of the present disclosure.

Regarding the SSB-RACH resource association, the mapping between SSB and RACH Occasion (RO) is defined by the following two RRC parameters: msg1-FDM, and ssb-perRACH-OccasionAndCB-PreamblesPerSSB. The parameter msg1-FDM specifies how many RO are allocated in frequency domain (at the same location in time domain). This parameter has a maximum value of 8, meaning the RAN can configure up to eight frequency resource instances in the time domain. The parameter ssb-perRACH-OccasionAndCB-PreamblesPerSSB specifies how many SSBs can be mapped to one RO and how many preamble indices can be mapped to single SSB.

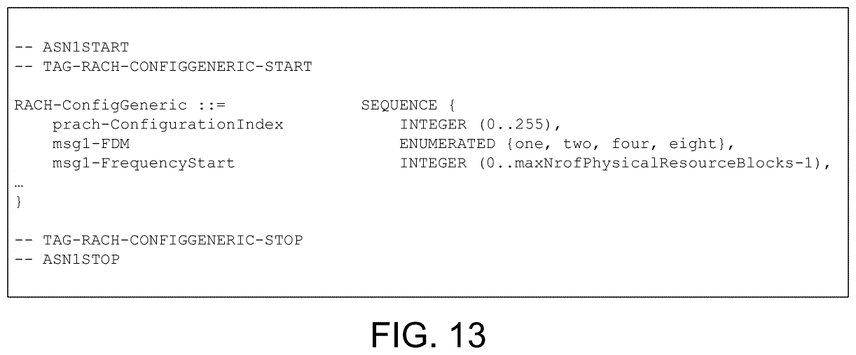

FIG. 13 illustrates an example of a RACH configuration IE in accordance with aspects of the present disclosure. In the example of FIG. 13, the RACH configuration IE may be a RACH-ConfigGeneric IE used by the network (e.g., gNB) to configure the UE with a PRACH configuration, including the pattern of valid ROs, the number of PRACH transmission occasions frequency division multiplexed (FDMed) in one time instance, and the offset of lowest PRACH transmission occasion in frequency domain with respective to PRB 0.

A description of the fields of the RACH-ConfigGeneric IE is given in Table 2, below.

TABLE 2

| | |
|---|---|
| msg1-FDM | The number of PRACH transmission occasions FDMed in one time |
| | instance, with a maximum value of 8. (see 3GPP Technical Specification |
| | (TS) 38.211, clause 6.3.3.2). |
| msg1- | Offset of lowest PRACH transmission occasion in frequency domain with |
| FrequencyStart | respective to PRB 0. The value is configured so that the corresponding |
| | RACH resource is entirely within the bandwidth of the UL bandwidth part |
| | (BWP). (see 3GPP TS 38.211, clause 6.3.3.2). |
| prach- | PRACH configuration index. For prach-ConfigurationIndex configured |
| ConfigurationIndex | under beamFailureRecoveryConfig, the prach-ConfigurationIndex can only |
| | correspond to the short preamble format, (see 3GPP TS 38.211, clause |
| | 6.3.3.2). If the field prach-ConfigurationIndex-v1610 is present, the UE |
| | shall ignore the value provided in prach-ConfigurationIndex (without suffix). |

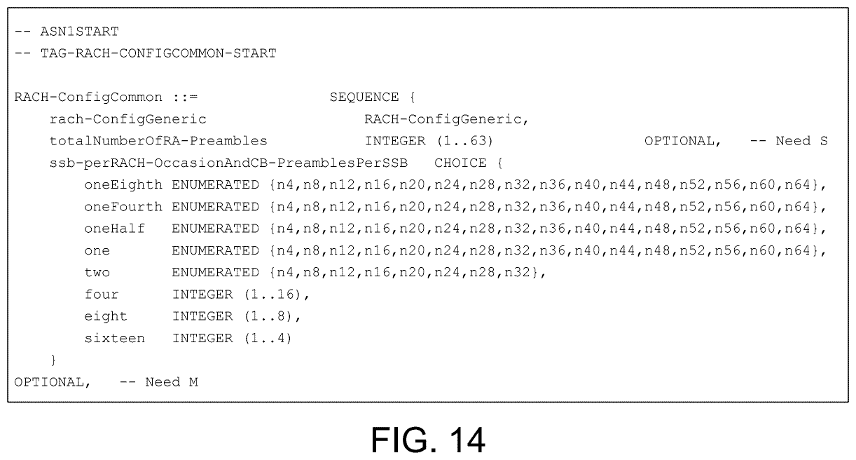

FIG. 14 illustrates another example of a RACH configuration IE in accordance with aspects of the present disclosure. In the example of FIG. 14, the RACH configuration IE may be a RACH-ConfigCommon IE used by the network (e.g., gNB) to configure the UE with a PRACH configuration, including the number of PRACH preambles, and a mapping of SSBs per RO, and preambles per SSB.

A description of the field of the RACH-ConfigCommon IE is given in Table 3, below.

TABLE 3

| | |
|---|---|
| ssb-perRACH- | The meaning of this field is twofold: the CHOICE conveys the |
| OccasionAndCB- | information about the number of SSBs per RACH occasion. Value |
| PreamblesPerSSB | oneEighth corresponds to one SSB associated with 8 RACH occasions, |
| | value oneFourth corresponds to one SSB associated with 4 RACH |
| | occasions, and so on. |
| | The ENUMERATED part indicates the number of Contention Based |
| | (CB) preambles per SSB. Value n4 corresponds to 4 CB preambles per |
| | SSB, value n8 corresponds to 8 CB preambles per SSB, and so on. The |
| | total number of CB preambles in a RACH occasion is given by CB- |
| | preambles-per-SSB × max(1, SSB-per-rach-occasion). See TS 38.213. |

Moreover, different phase array precoding architectures may be implemented for beamforming an RF signal, in accordance with aspects of the present disclosure.

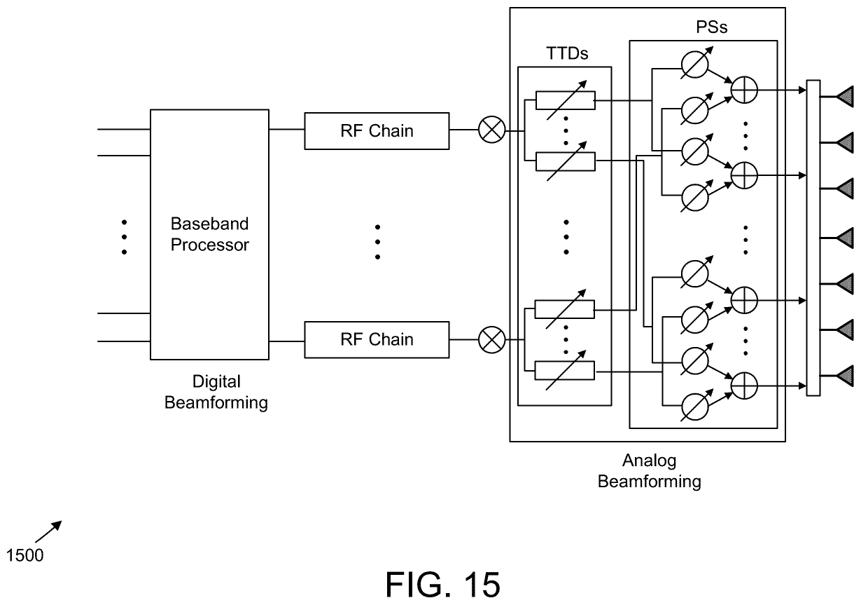

FIG. 15 illustrates an example of a fully connected precoding architecture in accordance with aspects of the present disclosure. In the example of FIG. 15, the fully connected architecture 1500 (which may also be referred to as an “fully connected structure”) comprises multiple RF chains, wherein each RF chain is connected to all antennae via true time-delay units (TTDs) and phase shifters (PSs). In the fully connected architecture 1500, the TTDs have the ability to delay a signal and according to the Fourier transform these time delays manifest as frequency dependent phase shifts in the frequency domain.

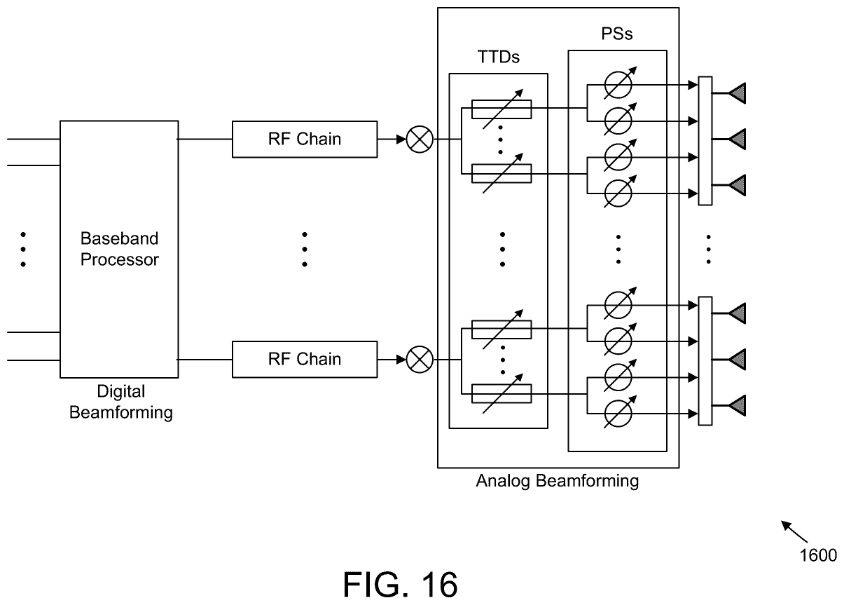

FIG. 16 illustrates an example of a sub-connected precoding architecture in accordance with aspects of the present disclosure. In contrast to the fully connected structure, each RF chain in the sub-connected architecture 1600 is only connected to a sub-array of the antenna array (which is also referred to as a “sub-connected structure”).

Utilization of the sub-connected structure may reduce both the hardware complexity and power consumption by exploiting fewer hardware components than the fully-connected structure. In particular, the number of phase shifters (PSs) can be substantially reduced. Additionally, for smaller antenna sub-arrays, the beam split effect is less pronounced, hence requiring a reduced number of TTDs for each sub-array. Moreover, the sub-connected structure can also help reduce the beamforming complexity. This is because the communication links between each sub-array and the users can be approximated by a far-field channel. Thus, low-complexity far-field channel models and state-of-the-art beamforming algorithms can be directly applied to each sub-array.

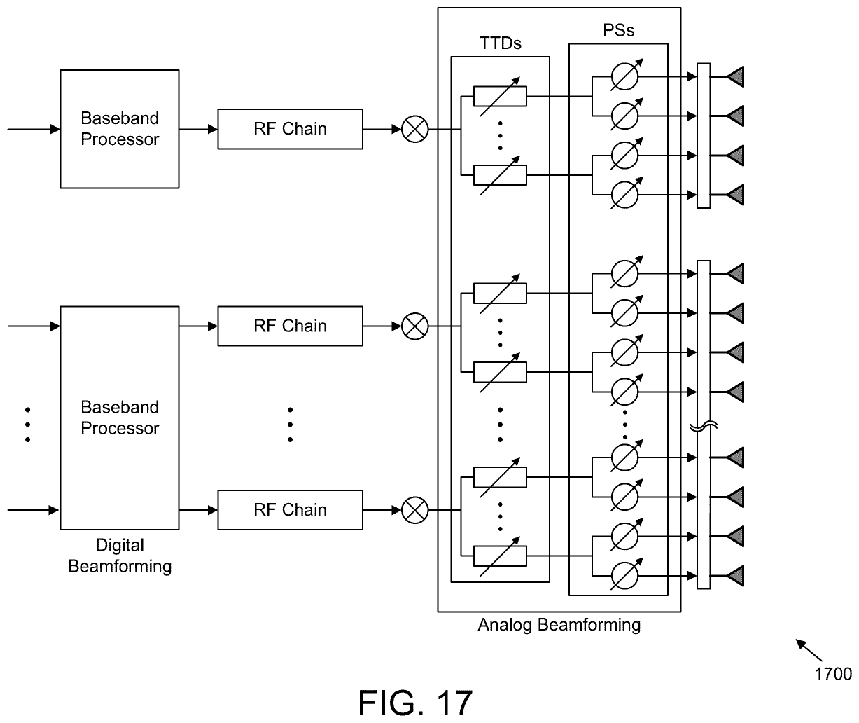

FIG. 17 illustrates an example of a hybrid precoding architecture in accordance with aspects of the present disclosure. In the example of FIG. 17, the hybrid beamforming architecture 1700, comprises multiple RF chains can be dynamically allocated among a plurality of baseband processing domains (i.e., where the digital beamforming occurs). Moreover, for ELAAs, the far-field beams and the near-field beams can be generated according to the hybrid beamforming architecture 1700 depending on the aperture size of the antenna array.

Consequently, users located originally in the near-field region of the entire antenna array can be considered as far-field regions for users using smaller sub-array, this is due to the limited RF chains required for the smaller sub-array resulting in low rank far-field channel. Thus, a far-field beam using planar wavefront can be generated by a smaller sub-array antenna structure and near-field beam using spherical wavefront can be generated by a larger sub-array or an entire antenna array of a XL-MIMO antenna array.

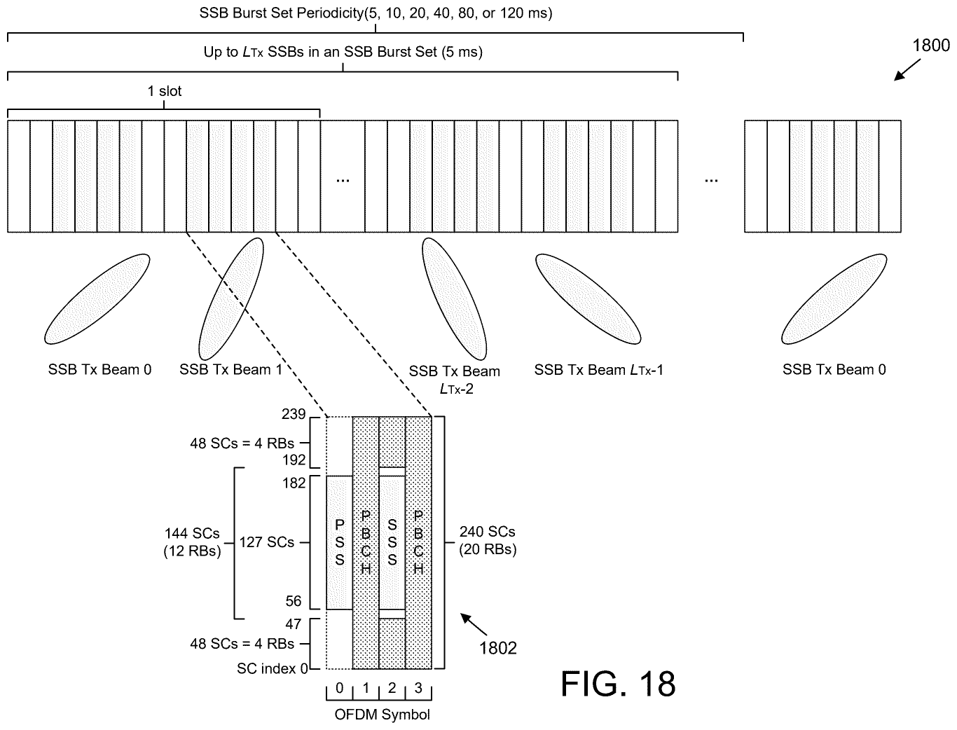

FIG. 18 illustrates an example of an SSB burst set 1800 comprising multiple SSB transmissions, in accordance with aspects of the present disclosure. A gNB (for example, one embodiment of the NE 102 described with reference to FIG. 1) may transmit the SSB burst set with a periodicity, such as 5 ms, 10 ms, 20 ms, 40 ms, 80 ms, or 120 ms. There are up to L_{TX} SSBs in the SSB burst set 1800, each associated with a different beam.

A respective SSB transmission 1802 includes the primary synchronization signal (PSS), the secondary synchronization signal (SSS), and the physical broadcast channel (PBCH). In the depicted embodiment, the SSB transmission duration is 4 OFDM symbols in the time domain, with the PSS and SSS each transmitted over 1 OFDM symbol, and the PBCH transmitted over 3 OFDM symbols.

In 5G NR, the SSB transmission 1802 spans 240 subcarriers in the frequency domain. The PSS and SSS span 127 subcarriers s at the center of the SSB transmission 1802. In the second and fourth OFDM symbols, the PBCH spans 240 subcarriers, while in the third OFDM symbol, the PBCH covers the 48 lowest subcarriers and the 48 highest subcarriers of the SSB transmission 1802.

In 5G NR, the resource block (RB) typically spans 12 subcarriers, and the bandwidth of the RB depends on the subcarrier spacing used in the 5G NR system. For example, for 15 kHz subcarrier spacing, the bandwidth of one RB is 180 kHz, while for 30 kHz subcarrier spacing, the bandwidth of one RB is 360 kHz. Similarly, for 60 kHz subcarrier spacing, the bandwidth of one RB is 720 kHz, while for 120 kHz subcarrier spacing, the bandwidth of one RB is 1.44 MHz

The duration of an RB in time is one slot, which may be composed of, e.g., 14 OFDM symbols in the time domain. In 5G NR, the time duration of an RB is based on the slot duration, which may vary according to the numerology and subcarrier spacing used. For example, for 15 kHz subcarrier spacing, the time duration of one RB (i.e., slot duration) is 1 ms, while for 30 kHz subcarrier spacing, the time duration of one RB (slot duration) is 0.5 ms. Similarly, for 60 kHz subcarrier spacing, the time duration of one RB (i.e., slot duration) is 0.25 ms, while for 120 kHz subcarrier spacing, the time duration of one RB (slot duration) is 0.125 ms.

For 5G NR, the starting symbols and number of SSBs as function of system carrier frequency and subcarrier spacing are defined in 3GPP TS 38.213

Regarding the mapping of random-access preambles to physical resources in 5G NR, the preamble sequence shall be mapped to physical resources according to the formula

$${a}_{k}^{( p , RA )} = {β}_{PRACH} {y}_{u , v} ( k )$$

$$k = 0 , 1 , … , {L}_{RA} - 1$$

where β_{PRACH} is an amplitude scaling factor in order to conform to the transmit power (e.g., as specified in 3GPP TS 38.213), and μ=4000 is the antenna port.

In 3GPP, the random access preambles can only be transmitted in the time resources obtained from specified tables, and depends on FR1 or FR2 and the spectrum type. The PRACH configuration index is given by the higher-layer parameter prach-ConfigurationIndex, or by msgA-PRACH-ConfigurationIndex, if configured; and given by the higher-layer parameter prach-ConfigurationIndex, or by msgA-PRACH-ConfigurationIndex, if configured.

Random access preambles can only be transmitted in the frequency resources given by either the higher-layer parameter msg1-FrequencyStart or msgA-RO-FrequencyStart if configured. The PRACH frequency resources n_{RA}∈{0, 1, . . . , M−1}, where M equals the higher-layer parameter msg1-FDM or msgA-RO-FDM if configured, are numbered in increasing order within the initial uplink bandwidth part during initial access, starting from the lowest frequency. Otherwise, n_{RA} are numbered in increasing order within the active uplink bandwidth part, starting from the lowest frequency.

An example of random access preamble configurations for FR1 and unpaired spectrum is shown in Table 4, below:

TABLE 4

| | | | | | | | ${N}_{t}^{RA , slot} ,$ | |
|---|---|---|---|---|---|---|---|---|
| | | | | | | | number | |
| | | | | | | | of time- | |
| | | | | | | Number | domain | |
| | | | | | | of | PRACH | |
| PRACH | | | | | | PRACH slots | occasions within a | ${N}_{dur}^{RA} ,$ |
| Configuration | Preamble | n_{f} mod x = y | | Subframe | Starting | within a | PRACH | PRACH |
| Index | format | x | y | number | symbol | subframe | slot | duration |
| 118 | A3 | 2 | 1 | 2, 3, 4, 7, 8, 9 | 0 | 1 | 2 | 6 |

For unpaired spectrum, if a UE is not provided tdd-UL-DL-ConfigurationCommon, a PRACH occasion in a PRACH slot is valid if it does not precede a synchronization signal/physical broadcast channel (SS/PBCH) block in the PRACH slot and starts at least N_{gap} symbols after a last SS/PBCH block reception symbol, where N_{gap} is provided by specification and, if channelAccessMode=“semiStatic” is provided, does not overlap with a set of consecutive symbols before the start of a next channel occupancy time where the UE does not transmit. The candidate SS/PBCH block index of the SS/PBCH block corresponds to the SS/PBCH block index provided by ssb-PositionsInBurst in SIB1 or in ServingCellConfigCommon.

For unpaired spectrum, if a UE is provided tdd-UL-DL-ConfigurationCommon, a PRACH occasion in a PRACH slot is valid if 1) it is within UL symbols, or 2) it does not precede a SS/PBCH block in the PRACH slot and starts at least N_{gap} Symbols after a last downlink symbol and at least N_{gap} symbols after a last SS/PBCH block symbol, where N_{gap} is provided by specification, and if channelAccessMode=“semiStatic” is provided, does not overlap with a set of consecutive symbols before the start of a next channel occupancy time where there shall not be any transmissions. Note that the candidate SS/PBCH block index of the SS/PBCH block corresponds to the SS/PBCH block index provided by ssb-PositionsInBurst in SIB1 or in ServingCellConfigCommon.

The SS/PBCH block indexes provided by ssb-PositionsInBurst in SIB1 or in ServingCellConfigCommon are mapped to valid PRACH occasions in the following order: 1) in increasing order of preamble indexes within a single PRACH occasion; 2) in increasing order of frequency resource indexes for frequency multiplexed PRACH occasions; 3) in increasing order of time resource indexes for time multiplexed PRACH occasions within a PRACH slot; and 4) in increasing order of indexes for PRACH slots

In the time domain, the ROs may be configured using higher-layer signaling. Because random access preambles can only be transmitted in the specified time resources, it follows that the time resources depend on the frequency band (e.g., FR1 or FR2) and the spectrum type.

In the frequency domain, on the other hand, the ROs are configured using two parameters: msg1-FDM, which indicates “The number of PRACH transmission occasions FDMed in one time instance”, which could be one of 1, 2, 4, or 8; and msg1-FrequencyStart, which indicates “Offset of lowest PRACH transmission occasion in frequency domain with respective to PRB 0”.

Additionally, a UE maps the provided

$${N}_{TX}^{SSB}$$

SSBs to valid ROs according to RRC parameter ssb-perRACH-OccasionAndCB-PreamblesPerSSB, as defined in Table 3. Moreover, SS/PBCH block (SSB) indexes provided by ssb-PositionsInBurst in SIB1 or in ServingCellConfigCommon are mapped to valid PRACH occasions in the following order: 1) in increasing order of preamble indexes within a single PRACH occasion; 2) in increasing order of frequency resource indexes for frequency multiplexed PRACH occasions; 3) in increasing order of time resource indexes for time multiplexed PRACH occasions within a PRACH slot; and 4) in increasing order of indexes for PRACH slots.

The above essentially implies that SSBs mapping to valid ROs are performed following a frequency first and time second ordering rule.

For example, if the number of SSBs

$${N}_{TX}^{SSB} = 8$$

and msg1-FDM=4. Then, FIG. 4-9 shows the SSBs to valid ROs mapping using the above mapping rules for different ssb-perRACH-Occasion (N) value. From FIG. 4-9, it can be observed that the required number of valid time domain ROs to map the provided SSBs depends on the configured ssb-perRACH-Occasion (N) value. For example, if N=1, i.e., one SSB is associated with one RO, then two time-domain of valid ROs are required to map the eight

$$( {N}_{TX}^{SSB} = 8 ) SSBs .$$

However, one time-domain of valid ROs is required to map the eight

$$( {N}_{TX}^{SSB} = 8 ) SSBs$$

if N=2 or N=4, whereas four time-domain of valid ROs are required to map the eight

$$( {N}_{TX}^{SSB} = 8 ) SSBs$$

### if N=½.

More importantly, FIG. 4-9 shows that if the valid time domain for ROs occur on single-bit full-duplex (SBFD) symbols, then some of the configured ROs (i.e., via msg1-FDM and msg1-FrequencyStart) might be allocated outside the SBFD UL subband. Moreover, depending on the provided number of SSBs per RO, i.e., ssb-perRACH-Occasion (N), some of the SSBs might be only mapped to a RO outside the configured SBFD UL subband, e.g., SSBs #0, SSBs #3, SSBs #4, and SSBs #7 when ssb-perRACH-Occasion (N) is equal to one. However, when ssb-perRACH-Occasion (N) is equal to 4, it can be observed that every SSB is mapped, at least once, to a RO within the configured SBFD UL subband. The same is true when ssb-perRACH-Occasion (N) is equal to ½. Therefore, with SBFD UL subband, different SSBs to ROs mapping rules are required.

From the above, it can be observed that as the carrier frequency and the number of antenna array elements N increases, the size of the near-field region increases and must be considered separately from the far-field, in part due to the use of beamforming in the near-field (i.e., “spotlight” beams) and also due to the increased proportion of UEs present in the near-field region of the antenna array of a gNB.

The legacy SSB-RACH beam association according to the ssb-perRACH-OccasionAndCB-PreamblesPerSSB overlooks (i.e., does not consider) the type of beam (e.g., near-field beam or far-field beam) associated with a transmission from the base station to the UE, and thus the legacy SSB-RACH beam association is insufficient for XL-MIMO. In certain embodiments, the base station may communicate additional information, such as an indication of the beam type of the beam optimal for the UE (e.g., the strongest beam, having best reception). The additional information may be helpful when performing beam scheduling, beam switching, beam refinement, beam measurement, etc. Hence, an SSB-RACH association for near-field and far-field beams could be separated, so that the type of beam is indicated to the UE and such beam association for initial access may factor in any QCL relationship among those SSB beams. For example, an SSB-RACH association for near-field beams may be separately indicated from the SSB-RACH association for far-field beams, such that each SSB-RACH association indicates the type of beam served to the UE.

Aspects of a first solution relate to initial access beam determination at the gNB, considering near-field beams or far-field beams, in accordance with the present disclosure. According to one embodiment, the gNB generates a plurality of SSB beams by transmitting a plurality of SSBs in an SSB burst. In certain embodiments, the gNB transmits a first SSB burst for the near-field region and transmits a second SSB burst for the far-field region.

For the near-field SSB burst, the beam used to transmit SSB changes in its depths/distances, angular direction, and its focus for each SSB in the near-field SSB burst. For the far-field SSB burst, the beam used to transmit SSB changes in its angular direction for each SSB in the far-field SSB burst. This creates beam sweeping such that the SSBs cover angular space of the coverage as well as beam focusing such as the SSBs cover different focusing distances in both the near-field and far-field regions of the antenna array. The SSBs with near-field focused beams in a first SSB burst and SSBs with far-field focused beams in a second SSB burst can be generated with using proper selection and phase shifting of the elements of the XL-MIMO antenna array.

In some embodiments of the first solution, the SSB beams generated using spherical wavefront (i.e., near-field SSB beams) may cover a wider spotlight area (i.e., a wider distance for the same wider angular direction) by varying the beam focusing similar to creating wider angular direction generated using beam-steering in 5G. Hence, many SSB beams may be needed to cover the near-field regions containing different distances or depths for the same angular dimensions and different angular directions, correspondingly different depths or distances and so on named as near-field polar domain.

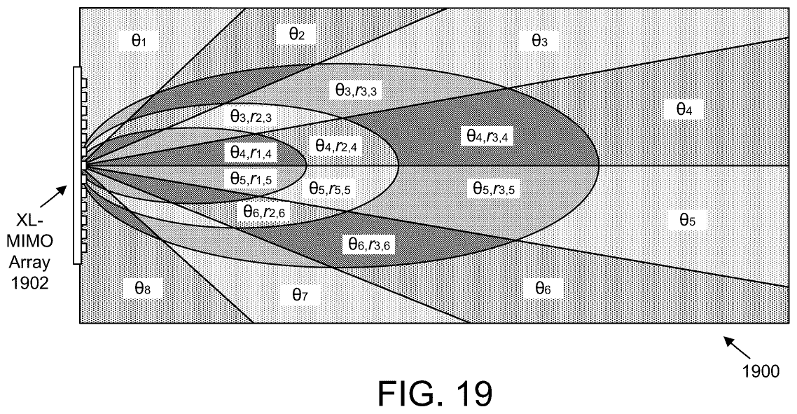

FIG. 19 illustrates an example of a polar domain mapping of near-field and far-field beams, in accordance with aspects of the present disclosure. In the example of FIG. 19, the polar domain mapping 1900 corresponds to the near-field and far-field regions generated by an XL-MIMO array 1902, in accordance with aspects of the present disclosure. In various embodiments, the near-field beams are mapped using a joint angular-distance dimension {θₙ,r_{s,n}}, where θₙ,r_{s,n} indicates the angular dimension for each directional index n, and r_{s,n} indicates the distance dimension for each depth index s and directional index n. In contrast, the near-field beams are mapped using an angular dimension {θₙ}, where θₙ, r_{s,n} indicates the angular dimension for each directional index n. In the depicted embodiment, the polar domain mapping 1900 includes 8 directions (i.e., n={1,2,3,4,5,6,7,8}) and 3 distances (i.e., s={1,2,3}).

As discussed above, the near-field distance (i.e., Fraunhofer distance using spherical wavefront) depends on the XL-MIMO array size and carrier frequency. At lower frequencies, or for smaller antenna arrays, the proportion of near-field distance compared to the overall cell radius may be less, hence the number of UEs proportionally located within near-field beams maybe less compared to UEs located within far-field beams. Consequently, the maximum (i.e., threshold) number of candidate near-field SSB beams in a near-field SSB burst may be configured separately from the far-field SSB beam configuration generated using planar wavefront. Additionally, the maximum number of candidate SSB beams in a near-field SSB burst may vary according to the frequency range (e.g., 7 to 24 GHZ, or 24 to 52 GHZ), the MIMO array size, or a combination thereof.

In an embodiment of the first solution, the SSB burst(s) containing plurality of SSBs can be separately configured for far-field SSB beams and near-field SSB beams, meaning there may be separate near-field SSB burst and far-field SSB burst. In certain embodiments, the SSB beams in the near-field regions may be designed to serve plurality of distances, or angular dimensions, or a combination thereof. In various embodiments, the near-field and far-field SSB bursts can be time domain multiplexed and transmitted separately with same or different periodicity, depending on the load conditions (e.g., the periodicities may be based on the number of UEs served/located within the near-field and far-field regions, respectively).

In some implementations, the candidate SSB time domain locations and the corresponding SSB index within each SSB burst may be configured separately according to SSB generation using near-field and far-field beams. For example, the periodicity of each of these SSB burst and an “ON/OFF” pattern of each SSB within each SSB burst may be varied independently depending on the SSB beams served in the near-field and far-field regions, e.g., based on their corresponding load conditions.

In one embodiment, when there are no UEs in the near-field region, then the near-field SSB burst may not be transmitted. In another embodiment, when the number of UEs is in the near-field region decreases, then the periodicity of the near-field SSB burst may be adapted (e.g., lengthened). In certain embodiments, when there are no UEs in a certain distance dimension, then corresponding SSB(s) may not be transmitted within a SSB burst. Such detection and determination can be inferred from one or more reception of RACH while the gNB provides a separate SSB-RACH mapping configuration for near-field and far-field SSB bursts.

In certain embodiments, a separate resource mapping definition for SSB-RACH resource mapping configuration transmitted by SIB1 may be signaled separately for near-field SSB beam to RACH and far-field SSB beam to RACH. The SSB-RACH resource mappings may vary according to the number of SSBs transmitted in each of these near-field and far-field SSB burst(s). Usually, the SSB-RACH resource mapping is same for all SSB bursts and in this case of near-field and far-field SSB bursts, the SSB-RACH resource mapping is different between SSB bursts according to the SSB burst type whether it is near-field or far-field.

In one example, the RRC parameter ssb-perRACH-OccasionAndCB-PreamblesPerSSB transmitted in SIB1 may be separately configured for the near-field SSB-RACH resource mapping and the far-field SSB-RACH resource mapping. In another example, msg-1-FDM values can be assumed to be the same for both near-field and far-field SSB-RACH resource mapping.

In one implementation, a separate PRACH resource mapping configuration between near-field and far-field SSBs can be used at the gNB to determine whether a UE(s) is served by near-field or far-field beams during the initial access.

In another implementation, an explicit signaling indicating the near-field or far-field SSB beams or SSB burst may be indicated in PBCH payload. In one example, a codepoint can be defined in a PBCH payload to signal the generation of SSB beams whether it is near-field or far-field SSBs value to the UE. Another example, PBCH demodulation reference signal (DMRS) sequence and/or sequence mapping can be differently configured for the near-field and far-field SSBs. UE may detect and/or select near-field or far-field SSB beam by using these additional information and select corresponding RACH resource.

The near-field SSB beams using beam focusing may contain plurality of distance related beamforming codebook configuration for the same angular direction while the far-field beamforming codebooks may be defined only for the angular direction. Hence a new QCL relationship can be defined between a respective SSB (or SSB beam, or SSB index) in the near-field SSB burst to the corresponding SSB (or SSB beam, or SSB index) in the far-field SSB burst, thereby implying that the SSBs (or SSB beams, or SSB indices) of these near-field and far-field SSB bursts may be related in the angular domain, i.e., having a QCL type-D relationship and/or using the same spatial filter.

In certain embodiments, one or more SSB (or SSB beam, or SSB index) of the near-field SSB burst can be configured to be QCL'ed with a block (or SSB beam, or SSB index) of the far-field SSB burst because of the presence of plurality of near-field SSB beams due to plurality of distance within a near-field region, e.g., as illustrated in FIG. 19.

In one implementation, such QCL'ed information between the SSB beams of near-field and far-field SSB bursts can be configured and signaled in various ways implicitly and explicitly, and the QCL relationship can be defined in the angular domain or spatial filter or depth or distance or combination thereof.

In certain embodiments, the PBCH DMRS sequence may be configured same for the SSB (or SSB beam, or SSB index) of near-field SSB burst and SSB (or SSB beam, or SSB index) of far-field SSB burst implicitly implying QCL relationship between the near-field and far-field SSB beams.

In certain embodiments, the PBCH DMRS density and mapping may be different for near-field SSBs and far-field SSB to enable optimal channel estimation for near-field and far-field consequently.

In certain embodiments, the SIB-1 may explicitly signal the QCL relationship between the SSB (or SSB beam, or SSB index) of near-field SSB burst and SSB (or SSB beam, or SSB index) of far-field SSB.

In various embodiments, the UE may select a SSB beam of highest RSRP by measuring the SSB beam of near-field and far-field SSB beams of their respective SSB bursts. In certain embodiments, the UE can determine near-field or far-field SSB beams, e.g., from explicit or implicit information in PBCH payload. In such embodiments, the UE may then perform hierarchical SSB beam selection. In the first iteration, the UE may select the far-field SSB beam according to the highest RSRP, while in the second iteration using the relationship between the near-field SSBs with that of the selected far-field SSB beam, the UE may select a near-field SSB beam with highest RSRP from plurality of near-field SSB beams configured according to different distances. The UE may further select a PRACH resource for the corresponding near-field SSB beam.

In certain embodiments, the gNB may configure a SSB threshold for the near-field SSB beams and the UE may determine whether a SSB beam is near-field or far-field based on the near-field SSB threshold. For example, if the SSB beam index or SSB burst index satisfies the near-field SSB beam threshold (e.g., is below the SSB threshold), then the UE may assume that the SSB beam is far-field. In one implementation, the SSB-RACH resource association may be related to the SSB threshold, and the UE may choose the RACH occasion according to far-field SSB-RACH resource mapping if the SSB beam index or SSB burst index is below the configured near-field SSB threshold.

Alternatively, the gNB may configure a SSB threshold for the far-field SSB beams and the UE may determine whether a SSB beam is near-field or far-field based on the far-field SSB threshold. For example, if the SSB beam index or SSB burst index satisfies the far-field SSB beam threshold (e.g., is above the SSB threshold), then the UE may assume that the SSB beam is near-field. In one implementation, the SSB-RACH resource association may be related to the SSB threshold, and the UE may choose the RACH occasion according to near-field SSB-RACH resource mapping if the SSB beam index or SSB burst index is above the configured far-field SSB threshold.

Aspects of a second solution relate to on-demand SSBs considering near-field beams or far-field beams, in accordance with the present disclosure. According to the second solution, the on-demand SSBs may be configured separately for near-field and far-field SSB burst(s). In such embodiments, the request for the on-demand SSB may contain explicit information for the transmission of near-field or far-field SSB burst(s).

In some embodiments, there may be separate UL wake up signal configurations for near-field and far-field SSB burst transmission. Accordingly, a gNB may determine whether a UE is located in the near-field or far-field region based on a received UL wakeup signal. In another implementation, depending on the received SINR or RSRP threshold or Timing Advance (TA) value at the gNB (e.g., estimated from the received request for on-demand SSB), the gNB may implicitly decide on the transmission of near-field or far-field SSB beams.

In one implementation, with separated configuration, the far-field SSB burst can be transmitted periodically while the near-field SSB burst can be transmitted using on-demand framework. In another implementation, with separated configuration, the far-field SSB burst can be periodically transmitted while the near-field SSB burst can be adaptively transmitted by varying periodicity, e.g., depending on the load condition (i.e., based on the quantity of UEs located within the near-field region of the gNB's antenna array). For example, the gNB may transmit the near-field SSB burst periodically (e.g., with varying, load-based periodicity) while at least a minimum number (i.e., threshold) of UEs are located within the near-field region. When the number of UEs located within the near-field region does not satisfy the threshold (e.g., drops below the minimum amount), the gNB may switch to transmitting the near-field SSB burst aperiodically or on-demand.

In another implementation, the far-field SSB burst may be transmitted in the synchronization frequency raster (i.e., global synchronization channel number (GSCN), absolute radio frequency channel number (ARFCH)) while the near-field SSB burst may be transmitted as non-cell-defining SSBs, meaning there is no control resource set index #0 (CORESET #0) associated with it and hence there is no required minimum system information blocks (e.g., no SIB1). In certain embodiments, a dedicated bandwidth part (BWP) may be configured for the UEs in the near-field regions and the near-field non-cell-defining SSBs may be transmitted within the dedicated BWP, while far-field SSB burst may be transmitted in the initial BWP as cell-defining SSBs (e.g., having CORESET #0 associated with it and hence containing required minimum system information blocks, such as SIB1).

Aspects of a third solution relate to the number of SSBs for the near-field region, in accordance with the present disclosure. According to the third solution, the ratio between the number of SSB near-field blocks to the number of SSB far-field blocks in an SSB burst depends on the deployment scenario and the related antenna array configuration.

In some embodiments, a sub-index of near-field SSBs (or SSB beams, or SSB indices) can be generated from far-field SSB beams, meaning the main SSB index indicates far-field SSB beams and a near-field sub-index of far-field SSB beams indicates the near-field SSB beams.

As an example, assume the far-field SSB indices can be SSB index #1, SSB index #2 and so on. Accordingly, the near-field SSB indices can be SSB index #1-1, SSB index #1-2, SSB index #2-1 and so on, meaning for every angular direction of far-field SSB beams, a plurality of sub-index of near-field SSB beams can be generated and transmitted. Such signaling of sub-index for near-field SSB beams can be handled implicitly or explicitly or a combination thereof.

In certain embodiments, a separate PBCH DMRS sequences can be used to distinguish the SSB indices and the same PBCH DMRS sequence may be configured for the SSB (or SSB beam, or SSB index) of near-field SSB burst and SSB (or SSB beam, or SSB index) of far-field SSB burst implicitly implying a QCL relationship between the near-field and far-field SSB beams. However, a separate PBCH payload indicates the sub-indices for the near-field SSB beams. Alternatively, the SIB1 may signal explicitly the QCL relationship between the SSB (or SSB beam, or SSB index) of near-field SSB burst and SSB (or SSB beam, or SSB index) of far-field SSB.

In other embodiments, the a separate near-field SSB bursts containing plurality of SSBs (or SSB beams, or SSB indices) may be configured for plurality of distances in a same angular domain of a far-field SSB (or SSB beam, or SSB index) of a far-field SSB burst, meaning for every far-field SSB (or SSB beam, or SSB index)—a separate near-field SSB bursts can be generated. For example, a SSB (or SSB beam, or SSB index) of far-field for an angular domain {θ₂}, then near-field SSB burst containing plurality of SSB (or SSB beam, or SSB index) for different distance of same angular domain can be generated meaning SSB bursts with SSB beam containing the joint angular-distance dimension {θ₂,r_{1,2}}, {θ₂,r_{2,2}}, etc. As such, each near-field SSB burst indicates the sub-indices of a QCL'ed far-field SSB beam.

Aspects of a fourth solution relate to a CSI-RS configuration for near-field and far-field regions, in accordance with the present disclosure. For the far-field region, the CSI-RS may be transmitted in a beam-steering manner, as described above with reference to FIGS. 6-7. For the near-field region, the CSI-RS may be transmitted in a beam-focusing manner, as described above with reference to FIGS. 8-9. Accordingly, the beam-focused CSI-RS may be transmitted to different focusing areas QCL'ed with the corresponding focused SSB. The QCL can be defined in the angular domain or spatial filter or depth or distance or combination thereof.

In some embodiments, the gNB may separately configure the CSI-RS configuration for the near-field region and the CSI-RS configuration for the far-field region. In certain embodiments, the gNB may configure and signal QCL information indicating the relation between the a SSB beam for the near-field and one or more CSI-RS beams (or focusing areas) for the near-field region. Such QCL configuration may be of distance or depth, angular or a combination thereof.

In some embodiments, a new QCL relationship can be defined between a respective SSB (or SSB beam, or SSB index) in the near-field SSB burst to the corresponding CSI-RS beam (or focusing area), thereby indicating that a SSB (or SSB beam, or SSB index) of the near-field SSB burst and one or more CSI-RS transmissions may be related in the angular domain, i.e., having a QCL type-D relationship and/or using the same spatial filter.

In various embodiments, separate CSI-RS resource sets may be configured for the near-field and far-field regions, where each CSI-RS resource set contains a plurality of CSI-RS resources that may be configured separately for near-field and far-field beamforming. In certain embodiments, each of these CSI-RS resource set can be separately QCL'ed with the near-field and far-field SSB beams. As described above, the near-field beams have a focusing region, where the beamforming gain diminishes rapidly outside the focusing region.

In some embodiments, the gNB may configure a UE with separate CSI-RS beams and beam failure detection reference signal (RS). In certain embodiments, the CSI-RS beams and beam failure detection RS can be configured as far-field CSI-RS resource(s) or far-field SSB(s), instead of near-field CSI-RS or near-field SSB.

In other embodiments, separate CSI-RS resource sets for near-field beams can be configured for varying distances and the near-field CSI-RS resource set can be QCL'ed either with near-field SSB beam(s) or far-field SSB beam(s) considering same angular domain. Hence, a separate transmission configuration indicator (TCI) state may indicate a near-field CSI-RS beam for every spotlight region, e.g., defined by the joint angular-distance dimension {θₙ,r_{s,n}}. In certain embodiments, the gNB may configure the UE with a depth-based TCI state table. Note that the TCI state is associated with the spatial direction of a transmitted signal and indicates which beam, or set of beams, should be used for demodulating the received signal.

In another implementation of the fourth solution, CSI-RS resource set can be configured for angular direction and each CSI-RS resource within a resource set can be configured for different distances in the near-field within the angular directions.

Note that this disclosure is not limited to any single embodiment and/or implementation elements individually, and one or more elements from one or more implementations and/or embodiments may be combined to construct a new embodiment.

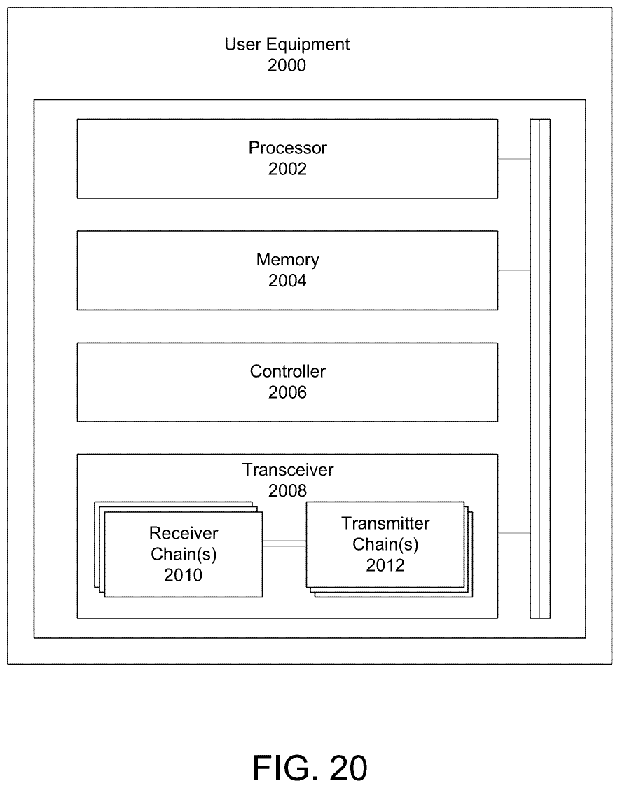

FIG. 20 illustrates an example of a UE 2000 in accordance with aspects of the present disclosure. The UE 2000 may include a processor 2002, a memory 2004, a controller 2006, and a transceiver 2008. The processor 2002, the memory 2004, the controller 2006, or the transceiver 2008, or various combinations thereof or various components thereof may be examples of means for performing various aspects of the present disclosure as described herein. These components may be coupled (e.g., operatively, communicatively, functionally, electronically, electrically) via one or more interfaces.

The processor 2002, the memory 2004, the controller 2006, or the transceiver 2008, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 2002 may include an intelligent hardware device (e.g., a general-purpose processor, a DSP, a central processing unit (CPU), an ASIC, a field programmable gate array (FPGA), or any combination thereof). In some implementations, the processor 2002 may be configured to operate the memory 2004. In some other implementations, the memory 2004 may be integrated into the processor 2002. The processor 2002 may be configured to execute computer-readable instructions stored in the memory 2004 to cause the UE 2000 to perform various functions of the present disclosure.

The memory 2004 may include volatile or non-volatile memory. The memory 2004 may store computer-readable, computer-executable code including instructions that, when executed by the processor 2002, cause the UE 2000 to perform various functions described herein. The code may be stored in a non-transitory computer-readable medium such the memory 2004 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 2002 and the memory 2004 coupled with the processor 2002 may be configured to cause the UE 2000 to perform one or more of the UE functions described herein (e.g., executing, by the processor 2002, instructions stored in the memory 2004). Accordingly, the processor 2002 may support wireless communication at the UE 2000 in accordance with examples as disclosed herein.

For example, the UE 2000 may be configured to support a means for receiving a SSB burst for a plurality of beams associated with one or more antenna arrays or sub-arrays. Here, the SSB burst may include a first SSB burst for initial access in a near-field region of an antenna array (or sub-array) or a second SSB burst for initial access in a far-field region of the antenna array. In some embodiments, the first SSB burst includes a first set of SSBs associated with a first set of transmission beams. In some embodiments, the second SSB burst includes a second set of SSBs associated with a second set of transmission beams.

In some embodiments, the first set of SSBs for initial access in the near-field region include non-cell-defining SSBs. In some embodiments, the second set of SSBs for initial access in the far-field region include cell-defining SSBs (e.g., including CORESET #0).

In some embodiments, the first set of transmission beams includes a plurality of spherical wavefront beams. In some embodiments, the second set of transmission beams includes a plurality of planar wavefront beams. In some embodiments, the antennal array includes at least one thousand antenna array elements and operates at a carrier frequency greater than 6 GHz.

The UE 2000 may be configured to support a means for receiving a configuration including an SSB-to-RO mapping based on an association of the SSB burst to a near-field region of the antenna array (or sub-array) or far-field region of the antenna array.

In some embodiments, the SSB-to-RO mapping further indicates a beam association between the first beam of the first set of transmission beams and a second beam of the second set of transmission beams, where the first beam and second beam are QCL'ed.

The UE 2000 may be configured to support a means for selecting the best beam with respect to the antenna array (or sub-array) from a plurality of SSB beams based on part of a PRACH resource configuration. The UE 2000 may be configured to support a means for transmitting a RACH signal using the best beam based at least in part on the PRACH resource configuration.

In some embodiments, a respective beam of the second set of transmission beams is QCL'ed with a plurality of beams of the first set of transmission beams (e.g., a respective far-field beam may be QCL'ed with multiple near-field beams). In some embodiments, the UE 2000 is configured to receive an indication of a beam type of a respective transmission beam, the beam type being a near-field beam or a far-field beam.

In some embodiments, a threshold number (e.g., maximum) of candidate beams for the first set of transmission beams is configured independently from a threshold quantity (e.g., maximum amount) of candidate beams for the second set of transmission beams. In certain embodiments, the threshold number of candidate beams for the first set of transmission beams is based on the size of the antenna array and the carrier frequency of the antenna array. In certain embodiments, the threshold number of candidate beams for the first set of transmission beams is based on an estimated number of UEs located within the near-field region.

In some embodiments, the first SSB burst is associated with a first set of candidate time domain locations and a corresponding set of SSB indices. In some embodiments, each beam of the first set of transmission beams is associated with a respective distance from the base station and a respective angular dimension (e.g., different beams correspond to different combinations of distance and angle/direction).

In some embodiments, a periodicity of the first SSB burst is based on the number of serving beams in the near-field region and a load condition of the serving beams. In some embodiments, the periodicity of the second SSB burst is independent of the periodicity of the first SSB burst.

In some embodiments, the UE 2000 is configured to cause the base station to: A) transmit, to a base station, a request for transmission of an on-demand SSB; and B) receive the on-demand SSB using a transmission beam from the first set of transmission beams, e.g., based on a distance from the base station being less than a Raleigh distance of the antenna array. In such embodiments, the distance from the base station is based at least in part on a SINR associated with the request, a RSRP associated with the request, a TA value associated with the UE, or a combination thereof.

In some embodiments, the UE 2000 is configured to: A) receive a configuration of a first CSI-RS resource set for beam management in the near-field region of the antenna array, where the first CSI-RS resource set is QCL'ed with the first set of transmission beams; and B) receive a configuration of a second CSI-RS resource set for beam management in the far-field region of the antenna array, where the second CSI-RS resource set is QCL'ed with the second set of transmission beams.

The controller 2006 may manage input and output signals for the UE 2000. The controller 2006 may also manage peripherals not integrated into the UE 2000. In some implementations, the controller 2006 may utilize an operating system (OS) such as iOS®, ANDROID®, WINDOWS®, or other operating systems. In some implementations, the controller 2006 may be implemented as part of the processor 2002.

In some implementations, the UE 2000 may include at least one transceiver 2008. In some other implementations, the UE 2000 may have more than one transceiver 2008. The transceiver 2008 may represent a wireless transceiver. The transceiver 2008 may include one or more receiver chains 2010, one or more transmitter chains 2012, or a combination thereof.

A receiver chain 2010 may be configured to receive signals (e.g., control information, data, packets) over a wireless medium. For example, the receiver chain 2010 may include one or more antennas for receiving the signal over the air or wireless medium. The receiver chain 2010 may include at least one amplifier (e.g., a low-noise amplifier (LNA)) configured to amplify the received signal. The receiver chain 2010 may include at least one demodulator configured to demodulate the received signal and obtain the transmitted data by reversing the modulation technique applied during transmission of the signal. The receiver chain 2010 may include at least one decoder for decoding/processing the demodulated signal to receive the transmitted data.

A transmitter chain 2012 may be configured to generate and transmit signals (e.g., control information, data, packets). The transmitter chain 2012 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 2012 may also include at least one power amplifier configured to amplify the modulated signal to an appropriate power level suitable for transmission over the wireless medium. The transmitter chain 2012 may also include one or more antennas for transmitting the amplified signal into the air or wireless medium.

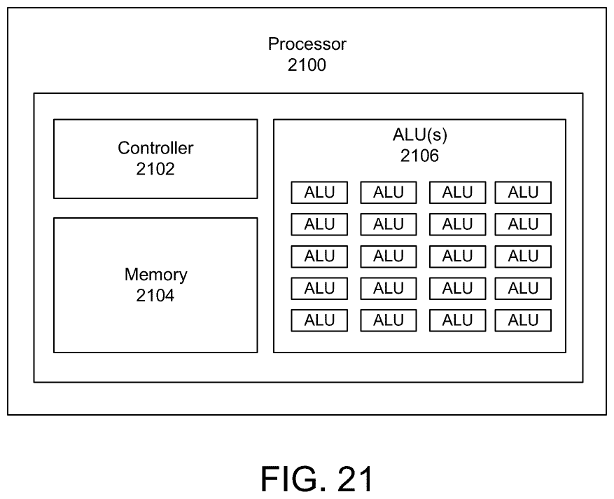

FIG. 21 illustrates an example of a processor 2100 in accordance with aspects of the present disclosure. The processor 2100 may be an example of a processor configured to perform various operations in accordance with examples as described herein. The processor 2100 may include a controller 2102 configured to perform various operations in accordance with examples as described herein. The processor 2100 may optionally include at least one memory 2104, which may be, for example, an L1/L2/L3 cache. Additionally, or alternatively, the processor 2100 may optionally include one or more arithmetic-logic units (ALUs) 2106. One or more of these components may be in electronic communication or otherwise coupled (e.g., operatively, communicatively, functionally, electronically, electrically) via one or more interfaces (e.g., buses).

The processor 2100 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 2100) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 2102 may be configured to manage and coordinate various operations (e.g., signaling, receiving, obtaining, retrieving, transmitting, outputting, forwarding, storing, determining, identifying, accessing, writing, reading) of the processor 2100 to cause the processor 2100 to support various operations in accordance with examples as described herein. For example, the controller 2102 may operate as a control unit of the processor 2100, generating control signals that manage the operation of various components of the processor 2100. These control signals include enabling or disabling functional units, selecting data paths, initiating memory access, and coordinating timing of operations.

The controller 2102 may be configured to fetch (e.g., obtain, retrieve, receive) instructions from the memory 2104 and determine subsequent instruction(s) to be executed to cause the processor 2100 to support various operations in accordance with examples as described herein. The controller 2102 may be configured to track memory address of instructions associated with the memory 2104. The controller 2102 may be configured to decode instructions to determine the operation to be performed and the operands involved. For example, the controller 2102 may be configured to interpret the instruction and determine control signals to be output to other components of the processor 2100 to cause the processor 2100 to support various operations in accordance with examples as described herein. Additionally, or alternatively, the controller 2102 may be configured to manage flow of data within the processor 2100. The controller 2102 may be configured to control transfer of data between registers, arithmetic logic units (ALUs), and other functional units of the processor 2100.

The memory 2104 may include one or more caches (e.g., memory local to or included in the processor 2100 or other memory, such RAM, ROM, DRAM, SDRAM, SRAM, MRAM, flash memory, etc. In some implementations, the memory 2104 may reside within or on a processor chipset (e.g., local to the processor 2100). In some other implementations, the memory 2104 may reside external to the processor chipset (e.g., remote to the processor 2100).

The memory 2104 may store computer-readable, computer-executable code including instructions that, when executed by the processor 2100, cause the processor 2100 to perform various functions described herein. The code may be stored in a non-transitory computer-readable medium such as system memory or another type of memory. The controller 2102 and/or the processor 2100 may be configured to execute computer-readable instructions stored in the memory 2104 to cause the processor 2100 to perform various functions. For example, the processor 2100 and/or the controller 2102 may be coupled with or to the memory 2104, the processor 2100, the controller 2102, and the memory 2104 may be configured to perform various functions described herein. In some examples, the processor 2100 may include multiple processors and the memory 2104 may include multiple memories. One or more of the multiple processors may be coupled with one or more of the multiple memories, which may, individually or collectively, be configured to perform various functions herein.

The one or more ALUs 2106 may be configured to support various operations in accordance with examples as described herein. In some implementations, the one or more ALUs 2106 may reside within or on a processor chipset (e.g., the processor 2100). In some other implementations, the one or more ALUs 2106 may reside external to the processor chipset (e.g., the processor 2100). One or more ALUs 2106 may perform one or more computations such as addition, subtraction, multiplication, and division on data. For example, one or more ALUs 2106 may receive input operands and an operation code, which determines an operation to be executed. One or more ALUs 2106 be configured with a variety of logical and arithmetic circuits, including adders, subtractors, shifters, and logic gates, to process and manipulate the data according to the operation. Additionally, or alternatively, the one or more ALUs 2106 may support logical operations such as AND, OR, exclusive-OR (XOR), not-OR (NOR), and not-AND (NAND), enabling the one or more ALUs 2106 to handle conditional operations, comparisons, and bitwise operations.

In various implementations, the processor 2100 may support the functions of a UE, in accordance with examples as disclosed herein. For example, the processor 2100 may be configured to support a means for receiving a SSB burst for a plurality of beams associated with one or more antenna arrays or sub-arrays. Here, the SSB burst may include a first SSB burst for initial access in a near-field region of an antenna array (or sub-array) or a second SSB burst for initial access in a far-field region of the antenna array. In some embodiments, the first SSB burst includes a first set of SSBs associated with a first set of transmission beams. In some embodiments, the second SSB burst includes a second set of SSBs associated with a second set of transmission beams.

In some embodiments, the first set of SSBs for initial access in the near-field region include non-cell-defining SSBs. In some embodiments, the second set of SSBs for initial access in the far-field region include cell-defining SSBs (e.g., including CORESET #0).

In some embodiments, the first set of transmission beams includes a plurality of spherical wavefront beams. In some embodiments, the second set of transmission beams includes a plurality of planar wavefront beams. In some embodiments, the antennal array includes at least one thousand antenna array elements and operates at a carrier frequency greater than 6 GHz.

The processor 2100 may be configured to support a means for receiving a configuration including an SSB-to-RO mapping based on an association of the SSB burst to a near-field region of the antenna array (or sub-array) or far-field region of the antenna array.

In some embodiments, the SSB-to-RO mapping further indicates a beam association between the first beam of the first set of transmission beams and a second beam of the second set of transmission beams, where the first beam and second beam are QCL'ed.

The processor 2100 may be configured to support a means for selecting the best beam with respect to the antenna array (or sub-array) from a plurality of SSB beams based on part of a PRACH resource configuration. The processor 2100 may be configured to support a means for transmitting a RACH signal using the best beam based at least in part on the PRACH resource configuration.

In some embodiments, a respective beam of the second set of transmission beams is QCL'ed with a plurality of beams of the first set of transmission beams (e.g., a respective far-field beam may be QCL'ed with multiple near-field beams). In some embodiments, the processor 2100 is configured to receive an indication of a beam type of a respective transmission beam, the beam type being a near-field beam or a far-field beam.

In some embodiments, a threshold number (e.g., maximum) of candidate beams for the first set of transmission beams is configured independently from a threshold quantity (e.g., maximum amount) of candidate beams for the second set of transmission beams. In certain embodiments, the threshold number of candidate beams for the first set of transmission beams is based on the size of the antenna array and the carrier frequency of the antenna array. In certain embodiments, the threshold number of candidate beams for the first set of transmission beams is based on an estimated number of UEs located within the near-field region.

In some embodiments, the first SSB burst is associated with a first set of candidate time domain locations and a corresponding set of SSB indices. In some embodiments, each beam of the first set of transmission beams is associated with a respective distance from the base station and a respective angular dimension (e.g., different beams correspond to different combinations of distance and angle/direction).

In some embodiments, a periodicity of the first SSB burst is based on the number of serving beams in the near-field region and a load condition of the serving beams. In some embodiments, the periodicity of the second SSB burst is independent of the periodicity of the first SSB burst.

In some embodiments, the processor 2100 is configured to cause the base station to: A) transmit, to a base station, a request for transmission of an on-demand SSB; and B) receive the on-demand SSB using a transmission beam from the first set of transmission beams, e.g., based on a distance from the base station being less than a Raleigh distance of the antenna array. In such embodiments, the distance from the base station is based at least in part on a SINR associated with the request, a RSRP associated with the request, a TA value associated with the UE, or a combination thereof.

In some embodiments, the processor 2100 is configured to: A) receive a configuration of a first CSI-RS resource set for beam management in the near-field region of the antenna array, where the first CSI-RS resource set is QCL'ed with the first set of transmission beams; and B) receive a configuration of a second CSI-RS resource set for beam management in the far-field region of the antenna array, where the second CSI-RS resource set is QCL'ed with the second set of transmission beams.

In various implementations, the processor 2100 may support the functions of a base station, in accordance with examples as disclosed herein. For example, the processor 2100 may be configured to support a means for transmitting a configuration that indicates a mapping between a SSB transmission to a RO, where the mapping is according to whether the SSB transmission is for a near-field region associated with an antenna array (or sub-array) or for a far-field region associated with the antenna array (or sub-array). The near-field distance can be determined from the antenna array (or sub-array) of a transmitter. In one or more implementations, widely-spaced distributed sub-arrays can generate near-field beams and near-field distance is estimated from each of the sub-arrays although the near-field distance can be an aggregation of each of the sub-arrays. Similarly, SSB beams using near-field beamforming can be generated from an antenna array or sub-array or a distributed sub-array structure. In some implementations, one or more UEs can be configured with a threshold to select near-field or far-field beams, wherein the UE(s) within the threshold can search and detect for near-field beams and UE(s) above the threshold can search and detect for far-field beams.

The processor 2100 may be configured to support a means for transmitting a plurality of SSB bursts based at least in part on the configuration, where the plurality of SSB bursts comprises a first SSB burst over a first set of beams for the near-field region associated with the antenna array (or sub-array), and a second SSB burst over a second set of beams for the far-field region associated with the antenna array (or sub-array), where the first SSB burst comprises a first set of SSBs, and where the second SSB burst comprises a second set of SSBs.

In some implementations, the processor 2100 is configured to: A) receive a RACH signal according to a PRACH resource configuration; and B) determine whether the user equipment (UE) is located within the near-field region or the far-field region associated with the antenna array based on the received RACH signal, e.g., with respect to a selection of i) a beam from the first set of beams or ii) a beam from the second set of beams.

In some implementations, the processor 2100 is configured to: A) receive, from the UE, a request for transmission of an on-demand SSB; and B) transmit the on-demand SSB using a beam from the first set of beams in response to an estimated distance to the UE being less than a Raleigh distance of the antenna array. Here, the estimated distance is based at least in part on a SINR associated with the request, a RSRP associated with the request, a TA value associated with the UE, or a combination thereof.

In some implementations, the mapping further indicates a beam association between a first beam of the first set of beams and a second beam of the second set of beams, where the first beam and second beam are QCL'ed. In some implementations, the first set of SSBs include non-cell-defining SSBs, where the second set of SSBs include cell-defining SSBs (i.e., the SSB transmission includes CORESET #0).

In some implementations, a respective beam of the second set of beams is QCL'ed with a plurality of beams of the first set of beams. In other words, a far-field beam is QCL'ed with multiple near-field beams. In some implementations, the at least one processor is configured to cause the base station to indicate a beam type of a respective beam, the beam type being a near-field beam or a far-field beam.

In some implementations, the first set of beams includes a plurality of spherical wavefront beams, and the second set of beams includes a plurality of planar wavefront beams. In such implementations, the antennal array may include at least one thousand antenna array elements and may operate at a carrier frequency greater than 6 GHz.

In some implementations, a threshold number (e.g., maximum) of candidate beams for the first set of beams is configured independently from a threshold quantity (e.g., maximum amount) of candidate beams for the second set of beams. In certain implementations, the threshold number of candidate beams for the first set of beams is based on the size of the antenna array and the carrier frequency of the antenna array. In certain implementations, the threshold number of candidate beams for the first set of beams is based on an estimated number of UEs located within the near-field region.

In some implementations, the first SSB burst is associated with a first set of candidate time domain locations and a corresponding set of SSB indices. In some implementations, each beam of the first set of beams is associated with a respective distance from the base station and a respective angular dimension (e.g., different beams correspond to different combinations of distance and angle/direction).

In some implementations, the periodicity of the first SSB burst is based on the number of serving beams for the near-field region associated with the antenna array and a load condition of the serving beams. In such implementations, the periodicity of the second SSB burst is independent of the periodicity of the first SSB burst.

In some implementations, the processor 2100 is configured to: A) transmit the first SSB burst periodically based on a load condition of the first set of beams satisfying a load threshold, and B) transmit the first SSB burst aperiodically, and on-demand based on the load condition of the first set of beams not satisfying the load threshold.

In some implementations, the processor 2100 is configured to: A) configure a first CSI-RS resource set for the near-field region associated with the antenna array, where the first CSI-RS resource set is QCL'ed with the first set of beams; and B) configure a second CSI-RS resource set for the far-field region associated with the antenna array, where the second CSI-RS resource set is QCL'ed with the second set of beams.

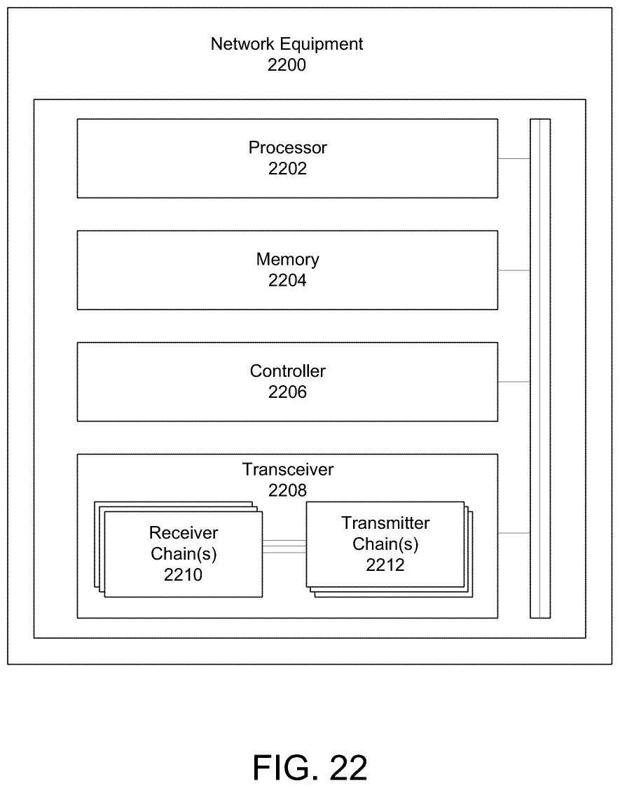

FIG. 22 illustrates an example of an NE 2200 in accordance with aspects of the present disclosure. The NE 2200 may include a processor 2202, a memory 2204, a controller 2206, and a transceiver 2208. The processor 2202, the memory 2204, the controller 2206, or the transceiver 2208, or various combinations thereof or various components thereof may be examples of means for performing various aspects of the present disclosure as described herein. These components may be coupled (e.g., operatively, communicatively, functionally, electronically, electrically) via one or more interfaces.

The processor 2202, the memory 2204, the controller 2206, or the transceiver 2208, or various combinations or components thereof may be implemented in hardware (e.g., circuitry). The hardware may include a processor, a DSP, an ASIC, or other programmable logic device, or any combination thereof configured as or otherwise supporting a means for performing the functions described in the present disclosure.

The processor 2202 may include an intelligent hardware device (e.g., a general-purpose processor, a DSP, a CPU, an ASIC, an FPGA, or any combination thereof). In some implementations, the processor 2202 may be configured to operate the memory 2204. In some other implementations, the memory 2204 may be integrated into the processor 2202. The processor 2202 may be configured to execute computer-readable instructions stored in the memory 2204 to cause the NE 2200 to perform various functions of the present disclosure.

The memory 2204 may include volatile or non-volatile memory. The memory 2204 may store computer-readable, computer-executable code including instructions when executed by the processor 2202 cause the NE 2200 to perform various functions described herein. The code may be stored in a non-transitory computer-readable medium such the memory 2204 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 2202 and the memory 2204 coupled with the processor 2202 may be configured to cause the NE 2200 to perform one or more base station functions as described herein (e.g., executing, by the processor 2202, instructions stored in the memory 2204). Accordingly, the processor 2202 may support the communication at the NE 2200 in accordance with examples as disclosed herein.

For example, the NE 2200 may be configured to support a means for transmitting a configuration that indicates a mapping between a SSB transmission to a RO, where the mapping is according to whether the SSB transmission is for a near-field region associated with an antenna array (or sub-array) or for a far-field region associated with the antenna array (or sub-array).

The NE 2200 may be configured to support a means for transmitting a plurality of SSB bursts based at least in part on the configuration, where the plurality of SSB bursts comprises a first SSB burst over a first set of beams for the near-field region associated with the antenna array (or sub-array), and a second SSB burst over a second set of beams for the far-field region associated with the antenna array (or sub-array), where the first SSB burst comprises a first set of SSBs, and where the second SSB burst comprises a second set of SSBs.

In some implementations, the NE 2200 is configured to: A) receive a RACH signal according to a PRACH resource configuration; and B) determine whether the user equipment (UE) is located within the near-field region or the far-field region associated with the antenna array based on the received RACH signal, e.g., with respect to a selection of i) a beam from the first set of beams or ii) a beam from the second set of beams.

In some implementations, the NE 2200 is configured to: A) receive, from the UE, a request for transmission of an on-demand SSB; and B) transmit the on-demand SSB using a beam from the first set of beams in response to an estimated distance to the UE being less than a Raleigh distance of the antenna array. Here, the estimated distance is based at least in part on a SINR associated with the request, a RSRP associated with the request, a TA value associated with the UE, or a combination thereof.

In some implementations, the mapping further indicates a beam association between a first beam of the first set of beams and a second beam of the second set of beams, where the first beam and second beam are QCL'ed. In some implementations, the first set of SSBs include non-cell-defining SSBs, where the second set of SSBs include cell-defining SSBs (i.e., the SSB transmission includes CORESET #0).

In some implementations, a respective beam of the second set of beams is QCL'ed with a plurality of beams of the first set of beams. In other words, a far-field beam is QCL'ed with multiple near-field beams. In some implementations, the at least one processor is configured to cause the base station to indicate a beam type of a respective beam, the beam type being a near-field beam or a far-field beam.

In some implementations, the first set of beams includes a plurality of spherical wavefront beams, and the second set of beams includes a plurality of planar wavefront beams. In such implementations, the antennal array may include at least one thousand antenna array elements and may operate at a carrier frequency greater than 6 GHz.

In some implementations, a threshold number (e.g., maximum) of candidate beams for the first set of beams is configured independently from a threshold quantity (e.g., maximum amount) of candidate beams for the second set of beams. In certain implementations, the threshold number of candidate beams for the first set of beams is based on the size of the antenna array and the carrier frequency of the antenna array. In certain implementations, the threshold number of candidate beams for the first set of beams is based on an estimated number of UEs located within the near-field region.

In some implementations, the first SSB burst is associated with a first set of candidate time domain locations and a corresponding set of SSB indices. In some implementations, each beam of the first set of beams is associated with a respective distance from the base station and a respective angular dimension (e.g., different beams correspond to different combinations of distance and angle/direction).

In some implementations, the periodicity of the first SSB burst is based on the number of serving beams for the near-field region associated with the antenna array and a load condition of the serving beams. In such implementations, the periodicity of the second SSB burst is independent of the periodicity of the first SSB burst.

In some implementations, the NE 2200 is configured to: A) transmit the first SSB burst periodically based on a load condition of the first set of beams satisfying a load threshold, and B) transmit the first SSB burst aperiodically, and on-demand based on the load condition of the first set of beams not satisfying the load threshold.

In some implementations, the NE 2200 is configured to: A) configure a first CSI-RS resource set for the near-field region associated with the antenna array, where the first CSI-RS resource set is QCL'ed with the first set of beams; and B) configure a second CSI-RS resource set for the far-field region associated with the antenna array, where the second CSI-RS resource set is QCL'ed with the second set of beams.

The controller 2206 may manage input and output signals for the NE 2200. The controller 2206 may also manage peripherals not integrated into the NE 2200. In some implementations, the controller 2206 may utilize an operating system such as iOS®, ANDROID®, WINDOWS®, or other operating systems. In some implementations, the controller 2206 may be implemented as part of the processor 2202.

In some implementations, the NE 2200 may include at least one transceiver 2208. In some other implementations, the NE 2200 may have more than one transceiver 2208. The transceiver 2208 may represent a wireless transceiver. The transceiver 2208 may include one or more receiver chains 2210, one or more transmitter chains 2212, or a combination thereof.

A receiver chain 2210 may be configured to receive signals (e.g., control information, data, packets) over a wireless medium. For example, the receiver chain 2210 may include one or more antennas for receiving the signal over the air or wireless medium. The receiver chain 2210 may include at least one amplifier (e.g., a low-noise amplifier (LNA)) configured to amplify the received signal. The receiver chain 2210 may include at least one demodulator configured to demodulate the received signal and obtain the transmitted data by reversing the modulation technique applied during transmission of the signal. The receiver chain 2210 may include at least one decoder for decoding/processing the demodulated signal to receive the transmitted data.

A transmitter chain 2212 may be configured to generate and transmit signals (e.g., control information, data, packets). The transmitter chain 2212 may include at least one modulator for modulating data onto a carrier signal, preparing the signal for transmission over a wireless medium. The at least one modulator may be configured to support one or more techniques such as AM, FM, or digital modulation schemes like PSK or QAM. The transmitter chain 2212 may also include at least one power amplifier configured to amplify the modulated signal to an appropriate power level suitable for transmission over the wireless medium. The transmitter chain 2212 may also include one or more antennas for transmitting the amplified signal into the air or wireless medium.

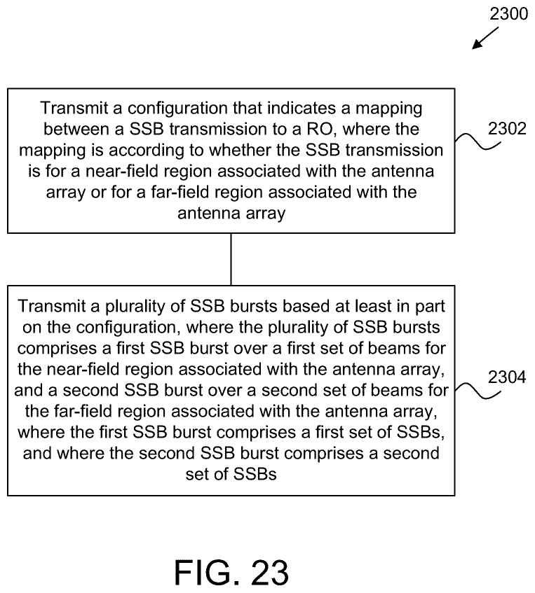

FIG. 23 depicts one embodiment of a method 2300 in accordance with aspects of the present disclosure. In various embodiments, the operations of the method 2300 may be implemented by a base station, as described herein. In some implementations, the base station may execute a set of instructions to control the function elements of the base station to perform the described functions.

At step 2302, the method 2300 may include transmitting a configuration that indicates a mapping between a SSB transmission to a RO, where the mapping is according to whether the SSB transmission is for a near-field region associated with the antenna array or for a far-field region associated with the antenna array. The operations of step 2302 may be performed in accordance with examples as described herein. In some implementations, aspects of the operations of step 2302 may be performed by an NE, as described with reference to FIG. 22.

At step 2304, the method 2300 may include transmitting a plurality of SSB bursts based at least in part on the configuration, where the plurality of SSB bursts comprises a first SSB burst over a first set of beams for the near-field region associated with the antenna array, and a second SSB burst over a second set of beams for the far-field region associated with the antenna array, where the first SSB burst comprises a first set of SSBs, and where the second SSB burst comprises a second set of SSBs. The operations of step 2304 may be performed in accordance with examples as described herein. In some implementations, aspects of the operations of step 2304 may be performed by an NE, as described with reference to FIG. 22.

It should be noted that the method 2300 described herein describes one possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A base station for wireless communication, comprising:
an antenna array;
at least one memory; and
at least one processor coupled with the at least one memory and configured to cause the base station to:
transmit a configuration that indicates a mapping between a synchronization signal block (SSB) transmission to a random-access channel occasion (RO), wherein the mapping is according to whether the SSB transmission is for a near-field region associated with the antenna array or for a far-field region associated with the antenna array; and
transmit a plurality of SSB bursts based at least in part on the configuration, wherein the plurality of SSB bursts comprises a first SSB burst over a first set of beams for the near-field region associated with the antenna array, and a second SSB burst over a second set of beams for the far-field region associated with the antenna array, wherein the first SSB burst comprises a first set of SSBs, and wherein the second SSB burst comprises a second set of SSBs.

2. The base station of claim 1, wherein the at least one processor is configured to cause the base station to:
receive a random-access channel (RACH) signal according to a physical RACH (PRACH) resource configuration; and
determine whether a user equipment (UE) is located within the near-field region or the far-field region associated with the antenna array based on the received RACH signal.

3. The base station of claim 1, wherein the at least one processor is configured to cause the base station to:
receive, from a user equipment (UE), a request for transmission of an on-demand SSB; and
transmit the on-demand SSB using a beam from the first set of beams in response to an estimated distance to the UE being less than a Raleigh distance of the antenna array,
wherein the estimated distance is based at least in part on a signal to interference plus noise ratio (SINR) associated with the request, a reference signal received power (RSRP) associated with the request, a timing advance (TA) value associated with the UE, or a combination thereof.

4. The base station of claim 1, wherein the mapping further indicates a beam association between a first beam of the first set of beams and a second beam of the second set of beams, wherein the first beam and second beam are quasi-co-located (QCL'ed).

5. The base station of claim 1, wherein the first set of SSBs comprise non-cell-defining SSBs, and wherein the second set of SSBs comprise cell-defining SSBs.

6. The base station of claim 1, wherein a respective beam of the second set of beams is quasi-co-located (QCL'ed) with a plurality of beams of the first set of beams.

7. The base station of claim 1, wherein the at least one processor is configured to cause the base station to indicate a beam type of a respective beam, the beam type being a near-field beam or a far-field beam.

8. The base station of claim 1, wherein the first set of beams comprises a plurality of spherical wavefront beams, wherein the second set of beams comprises a plurality of planar wavefront beams, and wherein the antennal array comprises at least one thousand antenna array elements and operates at a carrier frequency greater than 6 GHz.

9. The base station of claim 1, wherein a threshold number of candidate beams for the first set of beams is configured independently from a threshold quantity of candidate beams for the second set of beams.

10. The base station of claim 9, wherein the threshold number of candidate beams for the first set of beams is based on a size of the antenna array and a carrier frequency of the antenna array.

11. The base station of claim 9, wherein the threshold number of candidate beams for the first set of beams is based on an estimated number of user equipments (UEs) located within the near-field region.

12. The base station of claim 1, wherein the first SSB burst is associated with a first set of candidate time domain locations and a corresponding set of SSB indices, and wherein each beam of the first set of beams is associated with a respective distance from the base station and a respective angular dimension.

13. The base station of claim 1, wherein a periodicity of the first SSB burst is based on a number of serving beams for the near-field region associated with the antenna array and a load condition of the serving beams, and wherein a periodicity of the second SSB burst is independent of the periodicity of the first SSB burst.

14. The base station of claim 1, wherein the at least one processor is configured to cause the base station to:
transmit the first SSB burst periodically based on a load condition of the first set of beams satisfying a load threshold; and
transmit the first SSB burst aperiodically or on-demand based on the load condition of the first set of beams not satisfying the load threshold.

15. The base station of claim 1, wherein the at least one processor is configured to cause the base station to:
configure a first channel state information reference signal (CSI-RS) resource set for the near-field region associated with the antenna array, wherein the first CSI-RS resource set is quasi-co-located (QCL'ed) with the first set of beams; and
configure a second CSI-RS resource set for the far-field region associated with the antenna array, wherein the second CSI-RS resource set is QCL'ed with the second set of beams.

16. A processor for wireless communication, comprising:
at least one controller coupled with at least one memory and configured to cause the processor to:
transmit a configuration that indicates a mapping between a synchronization signal block (SSB) transmission to a random-access channel occasion (RO), wherein the mapping is according to whether the SSB transmission is for a near-field region associated with an antenna array or for a far-field region associated with the antenna array; and
transmit a plurality of SSB bursts based at least in part on the configuration, wherein the plurality of SSB bursts comprises a first SSB burst over a first set of beams for the near-field region associated with the antenna array, and a second SSB burst over a second set of beams for the far-field region associated with the antenna array, wherein the first SSB burst comprises a first set of SSBs associated with a first set of beams, and wherein the second SSB burst comprises a second set of SSBs associated with a second set of beams.

17. The processor of claim 16, wherein the at least one controller is configured to cause the processor to:
receive a random-access channel (RACH) signal according to a physical RACH (PRACH) resource configuration; and
determine whether a user equipment (UE) is located within the near-field region or the far-field region associated with the antenna array based on the received RACH signal.

18. The processor of claim 16, wherein the mapping further indicates a beam association between a first beam of the first set of beams and a second beam of the second set of beams, wherein the first beam and second beam are quasi-co-located (QCL'ed).

19. The processor of claim 16, wherein the first set of SSBs comprise non-cell-defining SSBs, and wherein the second set of SSBs comprise cell-defining SSBs, and wherein a respective beam of the second set of beams is quasi-co-located (QCL'ed) with a plurality of beams of the first set of beams.

20. A method performed by a base station, the method comprising:
transmitting a configuration that indicates a mapping between a synchronization signal block (SSB) transmission to a random-access channel occasion (RO), wherein the mapping is according to whether the SSB transmission is for a near-field region associated with an antenna array or for a far-field region associated with the antenna array; and
transmitting a plurality of SSB bursts based at least in part on the configuration, wherein the plurality of SSB bursts comprises a first SSB burst over a first set of beams for the near-field region associated with the antenna array, and a second SSB burst over a second set of beams for the far-field region associated with the antenna array, wherein the first SSB burst comprises a first set of SSBs associated with a first set of beams, and wherein the second SSB burst comprises a second set of SSBs associated with a second set of beams.
